(19) United States
(12) Patent Application Publication
(10) Pub. No.: US 2004/0039659 A1
(43) Pub. Date: Feb. 26, 2004

(54) Electronic purchasing system and method using mobile terminal and server and terminal apparatus in the system

(75) Inventor: Yushi Niwa, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/643,392

(22) Filed: Aug. 19, 2003

(30) Foreign Application Priority Data
Aug. 19, 2002 (JP) 2002-238501

(51) Int. Cl. G06F 17/60

(52) U.S. Cl. 705/26

(57) ABSTRACT

An electronic purchasing system, which can offer product information corresponding to the interest of users and can promote the sales of relating products by using mobile terminals, is provided. A user purchases a first product by transmitting an order of the first product to a first seller system by operating a mobile terminal. The first seller system transmits order sheet data, in which a first product purchased record of each of the users and product information of second product(s) relating to the first product(s) purchased by each of the users are described, to each of the mobile terminals. The user view the order sheet data on the mobile terminal, and when the user selects some second product(s), the order for the selected second product(s) is transmitted to a second seller system. The second seller system delivers the second product(s) to the mobile terminal of the user. The second seller system pays a commission to the first seller system as an advertisement effect for the second product(s).

### BACKGROUND OF THE INVENTION

The present invention relates to an electronic purchasing system and a method thereof by which a user can order a product (service) and purchase it by using a mobile terminal such as a mobile communication terminal, and a server and a terminal apparatus in the system.

Description of the Related Art

Since mobile terminals such as mobile communication terminals have been used largely, the demand of establishing an electronic purchasing system, by which a user can order a product (service) and purchase it by using a mobile terminal of the user, has become large.

As the electronic purchasing system using the mobile terminals, several systems are supposed. As an example, a system, by which a user can order a product (service) from a server managing by a product (service) seller by using the radio communication function of the mobile terminal of the user, is supposed. As another example, a system, in which a user orders some ringing tone music for a mobile communication terminal and digital data (digital contents data) such as image data and application programs from a server and the user purchases them by downloading, is supposed.

FIG. 1 is a block diagram showing the structure of a conventional electronic purchasing system using mobile terminals. As shown in FIG. 1, this conventional electronic system consists of a first seller system 101 that sells first products P1, a second seller system 105 that sells second products P2, and plural mobile terminals 108 of users (purchasers). The first seller system 101 provides a first seller server 102 being a center apparatus, first product information 103 storing the information of the first products P1, and plural first seller apparatuses 104 that are connected to the first seller server 102 via a communication network. The second seller system 105 provides a second seller server 106 being a center apparatus, and second product information 107 storing the information of the second products P2. Each of the plural mobile terminals 108 can order a product from one of the plural first seller apparatuses 104 or the second seller server 106 by accessing and connecting to it via a communication network by using the radio communication function of the mobile terminal.

Next, a case, in which the first seller system 101 is a system of a karaoke (sing-along music) company and the first products P1 are karaoke music data and the second seller system 105 is a system of a ringing tone music dealer and the second products P2 are ringing tone music data, is explained.

The first seller apparatus 104 is a communication karaoke apparatus, which plays some karaoke music, installed at a place such as a karaoke box (karaoke enjoying place). The first seller apparatus 104 is connected to the first seller server 102 via a communication network, and offers several services relating to the karaoke music. The first seller apparatus 104 plays some music requested by a user based on the input of music selection signal by the user. And the input of music selection signal by the user is an order for the first product(s) P1.

The second seller server 106 is a Web server and stores ringing tone music data being the second product P2, and delivers (downloads) the data of the second product(s) P2 to the mobile terminal 108 based on the access and the order of the mobile terminal 108 of the user.

The first seller system 101 offers the first product information 103 being the information of the products to be sold to the plural mobile terminals 108 of the users in a designated form. The second seller system 105 offers the second product information 107 being the information of the products to be sold to the plural mobile terminals 108 of the users in a designated form. The product information 103 and 107 includes, for example, the product name, the specification of the product, and the price of the product. Generally, the user browses the product information 103 and 107 in a form such a digital form and a paper medium printed out from the digital form and makes an order for the product. For example, when a user wants to purchase some ringing tone music data for his/her mobile communication terminal as its product, the user browses product information (advertisement information) in a designated digital form at the mobile communication terminal and views the information on a display of the mobile communication terminal. This product information includes the name of the music, the name of the singer, the offering price (including service) of the music, and the detail information of the music. After confirming the product (music), which the user wants to purchase, the user orders the product.

The typical product purchasing procedure at the electronic purchasing system using the mobile terminals is shown, for example, in the following. The user browses the product information (103,107) by using his/her own mobile terminal 108 or does not browses the product information (103,107) and selects a product that the user wants to purchase and inputs the decision of the purchasing by using his/her own mobile terminal 108. The mobile terminal 108 transmits the order information inputted by the user to the first seller system 101 or the second seller system 105 (the first seller apparatus 104 or the second seller server 106). The order information includes the ID (identifier) of the product to be ordered. The first seller system 101 or the second seller system 105 receives the order information from the mobile terminal 108 and processes the order, and executes the product delivering process. In this, the product delivering processes are different among the products. When the product is an article, a process delivering the article is executed. When the product is a service, a designated process is executed. When the product is some digital data, the process executing by a computer such as a process transmitting (downloading) the digital data is executed.

In case that the digital data is sold as the product, after receiving the product order at the seller system, the digital data is downloaded to the mobile terminal 108. The payment for the purchased product is executed by using a credit card system or a designated amount collecting service by a communication managing company.

At the electronic purchasing system mentioned above, in case that a user orders and purchases different products from different sellers, it is necessary for the user to order the different products by accessing the seller servers of the different sellers.

For example, at the conventional electronic purchasing system, the karaoke music delivering service and the ringing tone music delivering service are executed independently of each other. At the conventional electronic purchasing system mentioned above, the first product(s) P1 is the karaoke music data, and the second product(s) P2 is the ringing tone music data. In case that a user was interested in some music by using the karaoke music delivering service, and wanted to purchase the music for his/her ringing tone music, the user had to search the ringing tone music by using a Web searching service on his/her mobile terminal.

Further, in a case, a ringing tone music delivering dealer (second seller) has been advertising ringing tone music at places, where (karaoke boxes) a karaoke music delivering service dealer (first seller) delivers karaoke music, by putting a ringing tone music information list (paper medium). In this case, the second product(s) P2 (ringing tone music) were offered to users at the places offering the first product(s) P1 (karaoke music delivering service). However, since the product information of the ringing tone music is on the paper medium, even when a user had an interest in some music through the product information, the user had to order and purchase the second product(s) P2 by accessing the second seller.

At the conventional electronic purchasing systems mentioned above, the second product(s) P2 (ringing tone music data) is related to the first product(s) P1 (karaoke music data) in the points such as the name of the music and the name of the singer. However, the delivering the product information (advertisement information) and the procedure for purchasing the products are different from each other by the different seller systems. Therefore, the user had to search the seller and the product information and the address of the seller of the second product(s) P2 relating to the first product(s) P1 by himself/herself, and to access the address of the seller and order the product(s).

Further, some sellers of the ringing tone music data have executed the advertisement of the products by sending an e-mail having ringing tone music data list to users who were registered beforehand or to users selected at random. By this advertisement, some users have felt uncomfortable by receiving an undesirable e-mail or receiving product information in which the users were not interested.

At the conventional electronic purchasing systems mentioned above, in case that there exist different systems handling different products which have some relation, from the viewpoint delivering the product information (advertisement) to users, the services are not related each other. Further, the product information corresponding to the interests of the users is not offered.

### SUMMARY OF THE INVENTION

It is therefore an object of the present invention to provide an electronic purchasing system and method thereof by which a user can order products (services) and purchase them by using a mobile terminal such as a mobile communication terminal, and a server and a terminal apparatus in the system. At this electronic purchasing system, when a user ordered and purchased a first product(s) from a first seller by operating his/her own mobile terminal, the user can views the information of second products of a second seller, which relates to the first products. Further, the user can order and purchase a desiring product(s) in the second products with a simple procedure by viewing the product information of the second products on his/her mobile terminal. Therefore, the product information can be offered to the user corresponding to the interest of the user, and the sales of the products relating with each other can be promoted. With this, advantages can be given to the first seller and the second seller and the users (purchasers).

According to a first aspect of the present invention, for achieving the object mentioned above, there is provided an electronic purchasing system. The electronic purchasing system provides mobile terminals of users having a radio communication function, a first seller system for selling first products, and a second seller system for selling second products. And each of the users of the mobile terminals purchases the first product(s) by executing an order process for the first seller system by operating the mobile terminal, the first seller system transmits order sheet data, in which the information of first product purchased record of each of the users and second product information of the second product(s) relating to the first product(s) purchased by the user are described as combined information, to the mobile terminal of the user based on the purchase of the first product(s) by the user, the user views the order sheet data on the mobile terminal. And when the user selects some second product(s) in the second product information, an order process for the second product(s) selected by the user is executed to the second seller system, and the second seller system delivers the second product(s) ordered by the user to the mobile terminal of the user, and the second seller system pays a commission to the first seller system as an advertisement effect for the second product(s).

According to a second aspect of the present invention, there is provided an electronic purchasing system. The electronic purchasing system provides mobile terminals of users having a radio communication function, a first seller system for selling first products having a first seller server, and a second seller system for selling second products having a second seller server. And each of the mobile terminals provides a means that transmits first product order information for the first product(s) to the first seller server by an operation of the user. And the first seller server provides a means that receives the first product order information from the mobile terminal, and delivers the first product(s) to the mobile terminal, and makes a first product purchased record for the first product(s) purchased by the user, a means that relates the first product(s) purchased by the user to the second product(s) by referring to the information in the first product purchased record, and issues order sheet data, in which the information of the first product purchased record of each of the users and second product information of the second product(s) relating to the first product(s) purchased by the user are included in a combined state as display information, and further in which an process instruction that instructs to transmit second product order information to the second seller server when the user selected some second product(s) is described, and a means that transmits the order sheet data to the mobile terminal. And each of the mobile terminals further provides a means that displays the display information in the order sheet data, and transmits the second product order information to the second seller server when some second product(s) was selected by the user on the display information. And the second seller server provides a means that receives the second product order information and delivers the second product(s) to the mobile terminal, and a means that calculates a commission to be paid to the first seller system and transmits commission payment information including information of the calculated commission to the first seller server. And the first seller server further provides a means that confirms the commission payment based on the commission payment information.

According to a third aspect of the present invention, there is provided an electronic purchasing system. The electronic purchasing system provides mobile terminals of users having a radio communication function and a short distance communication function, a first seller system for selling first products having a first seller server and plural first seller apparatuses connecting to the first seller server, and a second seller system for selling second products having a second seller server. And each of the mobile terminals provides a means that transmits first product order information for the first product(s) to one of the plural first seller apparatuses via the short distance communication function by an operation of the user. And each of the plural first seller apparatuses provides a means that receives the first product order information from the mobile terminal, and delivers the first product(s) to the mobile terminal, and makes a first product purchased record for the first product(s) purchased by the user. And the first seller system provides a means that relates the first product(s) purchased by the user to the second product(s) by referring to the information in the first product purchased record, and issues order sheet data, in which the information of the first product purchased record of each of the users and second product information of the second product(s) relating to the first product(s) purchased by the user are included in a combined state as display information, and further in which an process instruction that instructs to transmit second product order information to the second seller server when the user selected some second product(s) is described, and a means that transmits the order sheet data to the mobile terminal. And each of the mobile terminals further provides a means that displays the display information in the order sheet data, and transmits the second product order information to the second seller server when some second product(s) was selected by the user on the display information. And the second seller server provides a means that receives the second product order information and delivers the second product(s) to the mobile terminal, and a means that calculates a commission to be paid to the first seller system and transmits commission payment information including information of the calculated commission to the first seller server. And the first seller server provides a means that confirms the commission payment based on the commission payment information.

According to a fourth aspect of the present invention, there is provided an electronic purchasing system. The electronic purchasing system provides mobile terminals of users having a radio communication function, a first seller system for selling first products having a first seller server, and a second seller system for selling second products having a second seller server. And each of the mobile terminals provides a means that transmits first product order information for the first product(s) to the first seller server by an operation of the user. And the first seller server provides a means that receives the first product order information from the mobile terminal, and delivers the first product(s) to the mobile terminal, and makes a first product purchased record for the first product(s) purchased by the user. And the second seller server provides a means that obtains the information of the first product purchased record from the first seller server, a means that relates the first product(s) purchased by the user to the second product(s) by referring to the information in the first product purchased record, and issues order sheet data, in which the information of the first product purchased record of each of the users and second product information of the second product(s) relating to the first product(s) purchased by the user are included in a combined state as display information, and further in which an process instruction that instructs to transmit second product order information to the second seller server when the user selected some second product(s) is described, and a means that transmits the order sheet data to the mobile terminal. And each of the mobile terminals further provides a means that displays the display information in the order sheet data, and transmits the second product order information to the second seller server when some second product(s) was selected by the user on the display information. And the second seller server further provides a means that receives the second product order information and delivers the second product(s) to the mobile terminal, and a means that calculates a commission to be paid to the first seller system and transmits commission payment information including information of the calculated commission to the first seller server. And the first seller server further provides a means that confirms the commission payment based on the commission payment information.

According to a fifth aspect of the present invention, in the fourth aspect, the second seller system calculates an information fee for the reception of the information of the first product purchased record from the first seller server as an additional commission to the first seller system and pays the information fee in addition to the commission to the first seller system.

According to a sixth aspect of the present invention, in the second or third aspect, the first seller system holds the second product information supplying from the second seller system beforehand and relates the second product(s) to the first product(s) by suing the first product information and the second product information, and issues the order sheet data.

According to a seventh aspect of the present invention, in the fourth aspect, the second seller system holds the first product information supplying from the first seller system beforehand and relates the second product(s) to the first product(s) by suing the first product information and the second product information, and issues the order sheet data.

According to an eighth aspect of the present invention, in any of the second to fourth aspects, a relation table between the first products and the second products is made beforehand, and the relation table is referred to when the order sheet data are issued.

According to a ninth aspect of the present invention, in the second or third aspect, the first seller system provides the first product information, and the second seller system provides the second product information, and the first seller system further provides a means that obtains the second product information from the second seller system, and a means that makes and renews a relation table in which the relation between the first products and the second products is described by applying a matching process to the first product information and the second product information obtained from the second seller system. And when the order sheet data are issued, the order sheet data are issued by referring to the relation table and making the relation between the first products and the second products.

According to a tenth aspect of the present invention, in the fourth aspect, the first seller system provides the first product information, and the second seller system provides the second product information. And the second seller system further provides a means that obtains the first product information from the first seller system, and a means that makes and renews a relation table in which the relation between the first products and the second products is described by applying a matching process to the second product information and the first product information obtained from the first seller system. And when the order sheet data are issued, the order sheet data are issued by referring to the relation table and making the relation between the first products and the second products.

According to an eleventh aspect of the persent invention, in the ninth or tenth aspect, at the matching process, text information in the first product information and the second product information is searched and compared, and when the same word is searched, the relation between the first products and the second products is made.

According to a twelfth aspect of the present invention, in any of the second to fourth aspects, when the first product order information is transmitted, address information of the mobile terminal is also transmitted, and when the order sheet data are transmitted, the address information of the mobile terminal is used as destination information.

According to a thirteenth aspect of the present invention, in any of the second to fourth aspects, when the order sheet data are issued, address information of the second seller server is also described in the order sheet data, and when the second product order information is transmitted, the address information of the second seller server is used as destination information.

According to a fourteenth aspect of the present invention, in any of the second to fourth aspects, when the order sheet data are issued, address information of the first seller server is also described in the order sheet data, when the second product order information is transmitted from the mobile terminal to the second seller server, the address information of the first seller server is also used as destination information, and the same data in the second product order information is transmitted to the first seller server for confirmation, and the first seller system confirms the commission payment by referring to the second product order information.

According to a fifteenth aspect of the present invention, in any of the second to fourth aspects, an e-mail address is used as the address information of the mobile terminal, and the first or second seller system transmits the order sheet data in the e-mail form by using the e-mail protocol.

According to a sixteenth aspect of the present invention, in any of the second to fourth aspects, the first products are digital data, and the first seller system transmits the digital data to the mobile terminal by receiving the first product order information.

According to a seventeenth aspect of the present invention, in any of the second to fourth aspects, the second products are digital data, and the second seller system transmits the digital data to the mobile terminal by receiving the second product order information.

According to an eighteenth aspect of the present invention, in any of the second to fourth aspects, the information of the first product purchased record and the second product information of each of the users, being the display information in the order sheet data, are displayed in different pages on the screen of the mobile terminal in a state that the different pages are changed over.

According to a nineteenth aspect of the present invention, in any of the second to fourth aspects, the information of the first product purchased record and the second product information of each of the users, being the display information in the order sheet data, are displayed in the same page on the screen of the mobile terminal in a state that both of the information is combined.

According to a twentieth aspect of the present invention, in the third aspect, the first seller system is a system that offers karaoke music data as the first products, each of the plural first seller apparatuses is a communication karaoke apparatus and plays karaoke music corresponding to the reception of the first product order information from each of the mobile terminals, and the second seller system is a system that offers ringing tone music data as the second products. And the second seller server holds the ringing tone music data and transmits the ringing tone music data to each of the mobile terminals corresponding to the reception of the second product order information from each of the mobile terminals.

According to a twenty-first aspect of the present invention, for achieving the object mentioned above, there is provided an electronic purchasing method electronic purchasing method in a system, in which mobile terminals of users having a radio communication function, a first seller system for selling first products having a first seller server, and a second seller system for selling second products having a second seller server are provided. The electronic purchasing method provides the steps of, transmitting first product order information for the first product(s) to the first seller server by an operation of the user at each of the mobile terminals, receiving the first product order information from the mobile terminal at the first seller server, delivering the first product(s) to the mobile terminal at the first seller server, making a first product purchased record for the first product(s) purchased by the user at the first seller server, relating the first product(s) purchased by the user to the second product(s) by referring to the information in the first product purchased record at the first seller server, issuing order sheet data, in which the information of the first product purchased record of each of the users and second product information of the second product(s) relating to the first product(s) purchased by the user are included in a combined state as display information, and further in which an process instruction that instructs to transmit second product order information to the second seller server when the user selected some second product(s) is described at the first seller server, transmitting the order sheet data to the mobile terminal at the first seller server, displaying the display information in the order sheet data at the mobile terminal, transmitting the second product order information to the second seller server when some second product(s) was selected by the user on the display information at the mobile terminal, receiving the second product order information and delivering the second product(s) to the mobile terminal at the second seller server, calculating a commission to be paid to the first seller system and transmitting commission payment information including information of the calculated commission to the first seller server at the second seller server, and confirming the commission payment based on the commission payment information at the first seller sever.

According to a twenty-second aspect of the present invention, there is provided an electronic purchasing method in a system, in which mobile terminals of users having a radio communication function and a short distance communication function, a first seller system for selling first products having a first seller server and plural first seller apparatuses connecting to the first seller server, and a second seller system for selling second products having a second seller server are provided. The electronic purchasing method provides the steps of, transmitting first product order information for the first product(s) to one of the plural first seller apparatuses via the short distance communication function by an operation of the user at each of the mobile terminals, receiving the first product order information from the mobile terminal, and delivering the first product(s) to the mobile terminal, and making a first product purchased record for the first product(s) purchased by the user at each of the plural first seller apparatuses, relating the first product(s) purchased by the user to the second product(s) by referring to the information in the first product purchased record at the first seller system, issuing order sheet data, in which the information of the first product purchased record of each of the users and second product information of the second product(s) relating to the first product(s) purchased by the user are included in a combined state as display information, and further in which an process instruction that instructs to transmit second product order information to the second seller server when the user selected some second product(s) is described at the first seller system, transmitting the order sheet data to the mobile terminal at the first seller system, displaying the display information in the order sheet data, and transmitting the second product order information to the second seller server when some second product(s) was selected by the user on the display information at each of the mobile terminals, receiving the second product order information and delivering the second product(s) to the mobile terminal at the second seller server, calculating a commission to be paid to the first seller system and transmitting commission payment information including information of the calculated commission to the first seller server at the second seller server, and confirming the commission payment based on the commission payment information at the first seller server.

According to a twenty-third aspect of the present invention, there is provided an electronic purchasing method in a system, in which mobile terminals of users having a radio communication function, a first seller system for selling first products having a first seller server, and a second seller system for selling second products having a second seller server are provided. The electronic purchasing method provides the steps of, transmitting first product order information for the first product(s) to the first seller server by an operation of the user at each of the mobile terminals, receiving the first product order information from the mobile terminal, and delivering the first product(s) to the mobile terminal, and making a first product purchased record for the first product(s) purchased by the user at the first seller server, obtaining the information of the first product purchased record from the first seller server at the second seller server, relating the first product(s) purchased by the user to the second product(s) by referring to the information in the first product purchased record at the second seller server, issuing order sheet data, in which the information of the first product purchased record of each of the users and second product information of the second product(s) relating to the first product(s) purchased by the user are included in a combined state as display information, and further in which an process instruction that instructs to transmit second product order information to the second seller server when the user selected some second product(s) is described at the second seller server, transmitting the order sheet data to the mobile terminal at the second seller server, displaying the display information in the order sheet data, and transmitting the second product order information to the second seller server when some second product(s) was selected by the user on the display information at each of the mobile terminals, receiving the second product order information and delivering the second product(s) to the mobile terminal at the second seller server, calculating a commission to be paid to the first seller system and transmitting commission payment information including information of the calculated commission to the first seller server at the second seller server, and confirming the commission payment based on the commission payment information at the first seller server.

According to a twenty-fourth aspect of the present invention, there is provided an electronic purchasing method in a system, in which mobile terminals of users having a radio communication function, a first seller system for selling first products having a first seller server, and a second seller system for selling second products having a second seller server are provided. The electronic purchasing method provides the steps of, transmitting first product order information for the first product(s) to the first seller server by an operation of the user at each of the mobile terminals, receiving the first product order information from the mobile terminal, and delivering the first product(s) to the mobile terminal, and making a first product purchased record for the first product(s) purchased by the user at the first seller server, obtaining the information of the first product purchased record from the first seller server at the second seller server, calculating an information fee for the reception of the information of the first product purchased record from the first seller server as an additional commission to the first seller system at the second seller server, relating the first product(s) purchased by the user to the second product(s) by referring to the information in the first product purchased record at the second seller server, issuing order sheet data, in which the information of the first product purchased record of each of the users and second product information of the second product(s) relating to the first product(s) purchased by the user are included in a combined state as display information, and further in which an process instruction that instructs to transmit second product order information to the second seller server when the user selected some second product(s) is described at the second seller server, transmitting the order sheet data to the mobile terminal at the second seller server, displaying the display information in the order sheet data, and transmitting the second product order information to the second seller server when some second product(s) was selected by the user on the display information at each of the mobile terminals, receiving the second product order information and delivering the second product(s) to the mobile terminal at the second seller server, calculating a commission to be paid to the first seller system for the purchase of the second product(s) by the user of the mobile terminal at the second seller server, transmitting commission payment information including information of the calculated commission and the information fee to the first seller server at the second seller server, and confirming the commission payment including the information fee based on the commission payment information at the first seller server.

According to a twenty-fifth aspect of the present invention, in the twenty-first or twenty-second aspect, the electronic purchasing method further provides the steps of, obtaining the second product information from the second seller system at the first seller system, and making and renewing a relation table in which the relation between the first products and the second products is described by applying a matching process to the first product information and the second product information obtained from the second seller system at the first seller system. And when the order sheet data are issued, the order sheet data are issued by referring to the relation table and making the relation between the first products and the second products.

According to a twenty-sixth aspect of the present invention, in the twenty-third or twenty-fourth aspects, the electronic purchasing method further provides the steps of, obtaining the first product information from the first seller system at the second seller system, and making and renewing a relation table in which the relation between the first products and the second products is described by applying a matching process to the second product information and the first product information obtained from the first seller system at the second seller system. And when the order sheet data are issued, the order sheet data are issued by referring to the relation table and making the relation between the first products and the second products.

According to a twenty-seventh aspect of the present invention, for achieving the object mentioned above, there is provided a server, which is a server of a first seller that sells first products to mobile terminals having a radio communication function of users. The server provides a function that receives first product order information from each of the mobile terminal, and delivers the first product(s) to each of the mobile terminal, a function that makes a first product purchased record for the first product(s) purchased by each of the users, a function that relates the first product(s) purchased by each of the users to second product(s) of a second seller by referring to the information in the first product purchased record, a function that issues order sheet data, in which the information of the first product purchased record of each of the users and second product information of second product(s) relating to the first product(s) purchased by each of the users are included in a combined state as display information, and further in which an process instruction that instructs to transmit second product order information to a server of the second seller when each of the users selected some second product(s) is described, a function that transmits the order sheet data to each of the mobile terminals, and a function that confirms a commission payment from the second seller based on commission payment information transmitted from the second seller.

According to a twenty-eighth aspect of the present invention, in the twenty-seventh aspect, the sever holds the product information of the first products. And the server further provides a function that obtains the product information of the second products from a system of the second seller, and a function that makes and renews a relation table in which the relation between the first products and the second products is described by applying a matching process to the product information of the first products and the product information of the second products obtained from the system of the second seller. And when the order sheet data are issued, the order sheet data are issued by referring to the relation table and making the relation between the first products and the second products.

According to a twenty-ninth aspect of the present invention, there is provided a server, which is a server of a second seller that sells second products to mobile terminals having a radio communication function of users. The server provides a function that receives second product order information issued based on order sheet data made by a system of a first seller from each of the mobile terminals, and delivers the first product(s) to each of the mobile terminal, and a function that calculates a commission to be paid to the first seller, and transmits commission payment information including the calculated commission to the system of the first seller.

According to a thirtieth aspect of the present invention, in the twenty-ninth aspect, the sever further provides a function that obtains information of a first product purchased record for first products purchased by each of the users from the system of the first seller, a function that relates the second products to the first products purchased by each of the users by referring to the information in the first product purchased record, a function that issues order sheet data, in which the information of the first product purchased record of each of the users and product information of second product(s) relating to the first product(s) purchased by each of the users are included in a combined state as display information, and further in which an process instruction that instructs to transmit second product order information to a server of the second seller, and a function that transmits the order sheet data to each of the mobile terminals.

According to a thirty-first aspect of the present invention, in the thirtieth aspect, the server holds the product information of said second products. And said server further provides a function that obtains said product information of said first products from a system of said first seller, and a function that makes and renews a relation table in which the relation between said first products and said second products is described by applying a matching process to said product information of said second products and said product information of said first products obtained from said system of said first seller. And when said order sheet data are issued, said order sheet data are issued by referring to said relation table and making the relation between said first products and said second products.

According to a thirty-second aspect of the present invention, for achieving the object mentioned above, there is provided an terminal apparatus, which is provided in a first seller system that delivers first product(s) to each of mobile terminals having a communication function of users and is connected to a server of said first seller system via a communication network. The terminal apparatus provides a function that delivers said first product(s) to each of said mobile terminals by communicating with said server, a function that receives first product information from each of said mobile terminals via short distance communication, and delivers said first product(s) to each of said mobile terminals, and a function that makes a first product purchased record based on the delivery of said first product(s) to each of said mobile terminals.

According to a thirty-third aspect of the present invention, in the thirty-second aspect, the terminal apparatus further provides a function that relates said first product(s) purchased by each of said users to second product(s) of a second seller by referring to the information in said first product purchased record, a function that issues order sheet data, in which said information of said first product purchased record of each of the users and second product information of second product(s) relating to said first product(s) purchased by each of said users are included in a combined state as display information, and further in which an process instruction that instructs to transmit second product order information to a server of said second seller when each of said users selected some second product(s) is described, and a function that transmits said order sheet data to each of said mobile terminals.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing the structure of a conventional electronic purchasing system using mobile terminals;

FIG. 2 is a block diagram showing the structure of an electronic purchasing system at a first embodiment of the present invention;

FIG. 3 is a block diagram showing the processes of the electronic purchasing system at the first embodiment of the present invention;

FIG. 4 is a table showing first product information of first products at the electronic purchasing system of the first embodiment of the present invention;

FIG. 5 is a table showing second product information of second products at the electronic purchasing system of the first embodiment of the present invention;

FIG. 6 is a diagram showing a relation table between the first and second products at the electronic purchasing system of the first embodiment of the present invention;

FIG. 7 is a table showing order information for the first products at the electronic purchasing system of the first embodiment of the present invention;

FIG. 8 is a table showing first product purchased record of the first products at the electronic purchasing system of the first embodiment of the present invention;

FIG. 9 is a block diagram showing the structure of a mobile terminal in the electronic purchasing system at the first embodiment of the present invention;

FIG. 10 is a diagram showing a displayed example of order sheet data on the display of the mobile terminal at the first embodiment of the present invention;

FIG. 11 is a table showing order information for the second products at the electronic purchasing system of the first embodiment of the present invention;

FIG. 12 is a block diagram showing the structure of a first seller server in a first seller system of the electronic purchasing system at the first embodiment of the present invention;

FIG. 13 is a table showing first product purchased information of the first products by each of the users at the electronic purchasing system of the first embodiment of the present invention;

FIG. 14 is a block diagram showing the structure of a second seller server in a second seller system of the electronic purchasing system at the first embodiment of the present invention;

FIG. 15 is a table showing second product information of the second products in each of the users at the electronic purchasing system of the first embodiment of the present invention;

FIG. 16 is a block diagram showing the structure of an electronic purchasing system at a second embodiment of the present invention;

FIG. 17 is a block diagram showing the structure of a first seller apparatus in the first seller system of the electronic purchasing system at the second embodiment of the present invention;

FIG. 18 is a diagram showing an operation sequence of the electronic purchasing system at the second embodiment of the present invention;

FIG. 19 is a block diagram showing the structure of an electronic purchasing system at a third embodiment of the present invention;

FIG. 20 is a diagram showing an operation sequence of the electronic purchasing system at the third embodiment of the present invention;

FIG. 21 is a diagram showing an operation sequence of an electronic purchasing system at a fourth embodiment of the present invention; and

FIG. 22 is a block diagram showing the structure of an electronic purchasing system at a fifth embodiment of the present invention.

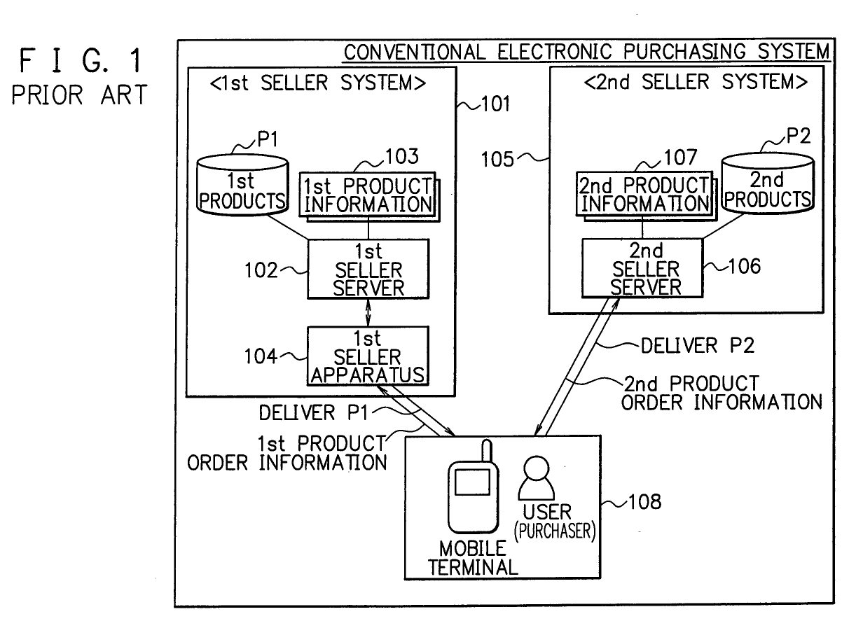

### DESCRIPTION OF THE PREFERRED EMBODIMENTS

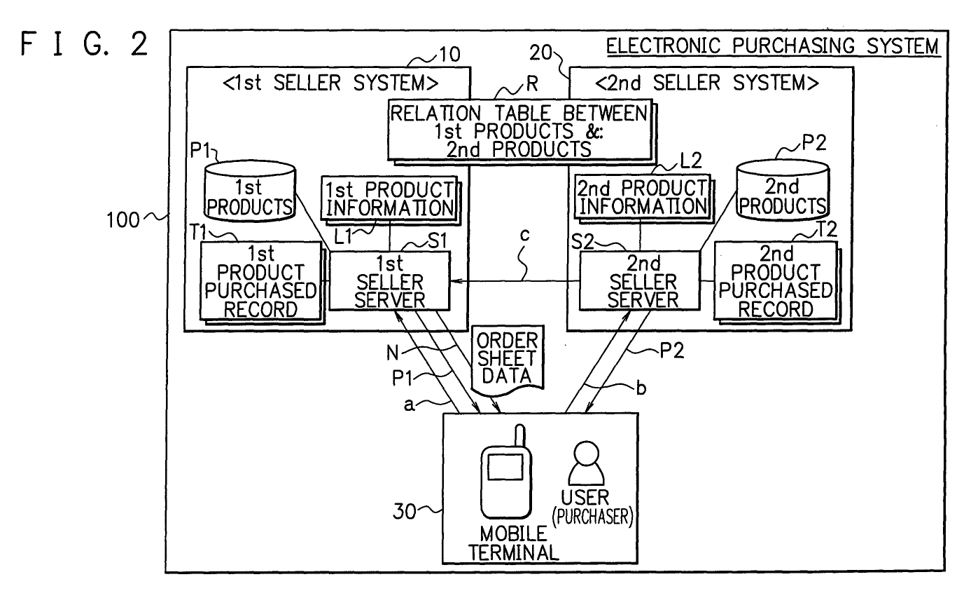

Referring now to the drawings, embodiments of the present invention are explained in detail. FIG. 2 is a block diagram showing the structure of an electronic purchasing system at a first embodiment of the present invention. As shown in FIG. 2, an electronic purchasing system 100 at the first embodiment of the present invention consists of a first seller system 10, a second seller system 20, and mobile terminals 30 of users (purchasers). The first seller system 10 is an information processing system of a first seller, and the second seller system 20 is an information processing system of a second seller. And the first seller system 10, the second seller system 20, and the mobile terminals 30 are connected via a communication network such as a public telephone network, and designated communication processes are executed among them. The mobile terminals 30 are radio communication terminals such as mobile communication terminals.

In this, at the first embodiment of the present invention, two seller systems are provided, however, the number of the seller systems is not limited to two, and two or more seller systems can be provided in the electronic purchasing system 100. However, in order to make the explanation concise, at the explanation of the embodiments of the present invention, two seller systems are used.

The first seller system 10 provides a first seller server S1, first products P1, first product information L1, and a first product purchased record T1. The first seller system 10 sells the first products P1. The first seller server S1 receives orders for the first products P1 and processes the orders and also processes delivering the ordered first products P1. In this, the first products P1 can be articles, services, or digital data. Electronically possible selling procedures for the first products P1 are processed in the first seller system 10.

The second seller system 20 provides a second seller server S2, second products P2, second product information L2, and a second product purchased record T2. The second seller system 20 sells the second products P1. The second seller server S2 receives orders for the second products P2 and processes the orders and also processes delivering the ordered second products P2. In this, the second products P2 can be articles, services, or digital data. Electronically possible selling procedures for the second products P1 are processed in the second seller system 20.

The mobile terminals 30 are radio communication terminals such as mobile communication terminals of users (purchasers), who purchase the first products P1 and the second products P2 by using the electronic purchasing system 100. As the mobile terminals 30, movable units having a radio communication function such as mobile communication terminals and personal digital assistants (PDA) can be used. At the explanation mentioning below, it is assumed that the mobile terminals 30 are the mobile communication terminals.

At the electronic purchasing system 100 at the first embodiment of the present invention, information data necessary for the processes are made by the mobile terminals 30 of the users and the first seller system 10 and the second seller system 20. That is, based on the results of the order and purchase of the first products P1 in the first seller system 10 by the mobile terminals 30, information data, in which the information of the first product purchased record T1 of the first products P1 by the mobile terminal 30 and product information of the second products P2 relating to the first products P1 are combined. And the combined information data are transmitted to the mobile terminals 30.

The user of the mobile terminal 30 can confirm the information of the first product purchased record T1 and can obtain the product information of the second products P2 relating to the first products P1 by viewing the information data on the mobile terminal 30. These information data are written by a language such as a markup language and are transmitted to the mobile terminal 30 in a designated form such as an e-mail form. The information data are written so that order information for the second products P2 is issued automatically when an item of the second products P2 is selected. Therefore, the user can order a desiring item(s) in the second products P2 by a simple operation such as a selecting and clicking operation on the mobile terminal 30 of the user. When the user operated the ordering process, the order information of the desiring item(s) of the second products P2 is issued and the issued order information is transmitted to the second seller system 20. Since the information data are written in a form that the item(s) of the second products P2 can be ordered easily, and the information data can be called as an order sheet data N.

When the second products P2 sold by using the operation mentioned above, the second seller pays a commission to the first seller, based on a designated basis such as the number of the sold second products P2. This commission can be considered as a commission for the effect of the advertisement of the second products P2.

At the time when the information data are transmitted to the mobile terminal 30 from the first seller system 10, the address information of the mobile terminal 30, which corresponds to the form of the information data and the protocol using at the transmitting process, is required. However, the address information has been transmitted to the first seller system 10 at the order process for the first products P1. Therefore, this address information can be used. The concept mentioned above is a big feature of the present invention.

At the electronic purchasing system 100 at the first embodiment of the present invention, the information, which is transmitted to the mobile terminal 30, is the information in which the information of the first product purchased record T1 is combined with the second product information L2 relating to the first products P1 purchased by the user. And the information of the second products P2, which the user is not interested in, is not transmitted at random. In case that an advertisement is delivered to the user without the interest of the user, the user is bothered by the advertisement. However, in this case, the user is not bothered by the information.

Further, the information data can promote the purchase of the second products P2 by the user, that is, the information data have an advertisement effect. The user can order the second product P2, when the user had an interest in the second products P2, by viewing the information of the first product purchased record T1 of the user himself/herself and the second product information L2 relating to the user purchased first product P1. Further, it is not necessary for the user to view the second product information L2, when the user is not interested in. Moreover, the user can order the second product P2 by a simple operation such as selecting and clicking operation on the mobile terminal. This is convenient for the user.

At the electronic purchasing system of the first embodiment of the present invention, in case that the first seller and the second seller are selling products, which are related with each other well, the products sell to the user by making the relation between the first products P1 and the second products P2. The relation between the first products P1 and the second products P2 is made by matching the first product purchased record T1 with the second product information L2, or by matching the first product information L1 with the second product information L2. And a relation table R between the first products P1 and the second products P2, in which the relation between the first and second products P1 and P2 is written, is made. And this relation table R is stored in the first seller system 10 or in the second seller system 20, and the relation table R is referred in case of necessity.

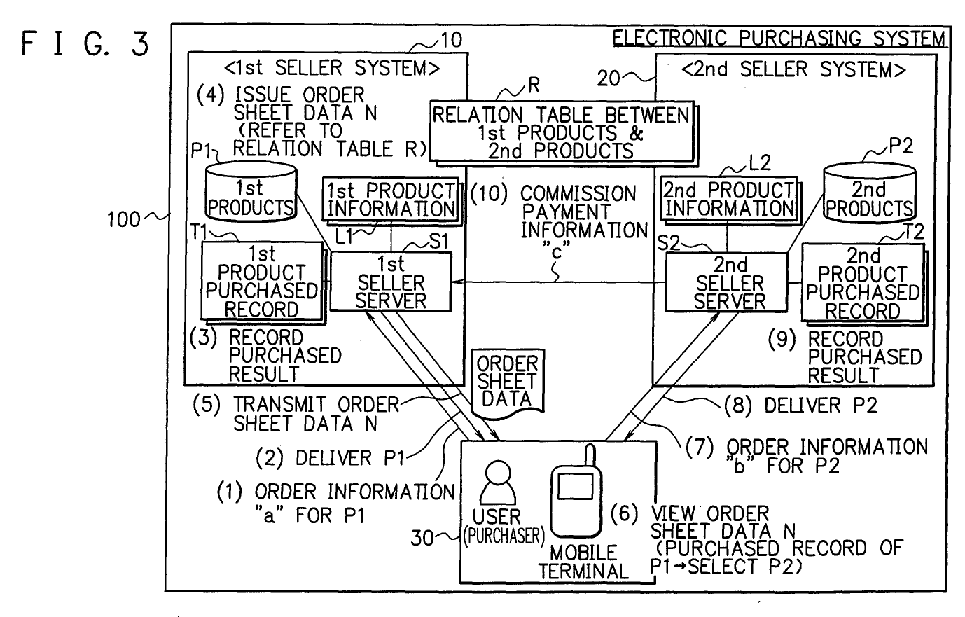

FIG. 3 is a block diagram showing the processes of the electronic purchasing system at the first embodiment of the present invention. Referring to FIG. 3, the processes of the electronic purchasing system 100 at the first embodiment of the present invention is explained. In FIG. 3, a number in ( ) shows the number in the processes.

First, the user of the mobile terminal 30 transmits order information “a” for purchasing a first product(s) P1 to the first seller server S1 in the first seller system 10, by operating the mobile terminal 30(1). The order information “a” includes the address information A3 being the address information of the mobile terminal 30. Next, the first seller server S1 receives the order information “a” and delivers the first product(s) P1 to the mobile terminal 30(2). And the purchased result of the first product(s) P1 by the mobile terminal 30 is recorded in the first product purchased record T1 in the first seller system 10(3). Information data (order sheet data N), in which the first product purchased record T1′ of the user himself/herself and the second product information L2′ relating to the purchased first product(s) P1 were written, are formed in a format such as a markup language format and an e-mail format (4). In this, “′” signifies that the information is for each of the users. And the order sheet data N is transmitted to the mobile terminal 30 of the user by using the address information A3 as its destination address (5).

At the mobile terminal 30 of the user, the received order sheet data N can be displayed at any time, and the user can refer to the first product purchased record T1′ of the purchased first products P1, by viewing the display information of the order sheet data N. Further, the user can refer to the second product information L2′ of the second products P2 relating to the first products P1 that the user purchased, by viewing the display information of the order sheet data N. In case that an item(s), which the user wants to purchase, exists in the second product information L2′, the user selects and decides the item(s) (6). And the order information “b” for purchasing the second product(s) P2 is transmitted to the second seller server S2 in the second seller system 20, by the selecting and deciding operation of the user (7). In this, the second product information L2′ is formed in a data format so that the order information “b” can be issued by selecting and deciding an item(s) in the second product information L2′. Therefore, the user orders the desiring item(s) by only the selection and the decision. And the order information “b” for purchasing the second product(s) P2 is transmitted.

The second seller server S2 receives the order information “b” and delivers the second product(s) P2 to the mobile terminal 30 (8). And the purchased result of the second product(s) P2 by the mobile terminal 30 is recorded in the second product purchased record T2 in the second seller system 20 (9).

The second seller pays a commission to the first seller, because the second seller obtained the effect of the advertisement of the second products P2 from the first seller, by that the second product P2 was related with the first product P1. The second seller system 20 calculates the commission for the effect of the advertisement of the second products P2 for the first seller system 10 at designated timing, based on a designated basis such as the sold result of the second products P2. And the second seller system 20 transmits commission payment information “c” based on the calculation to the first seller system 10 (10).

Next, several conditions at the electronic purchasing system 100 of the first embodiment of the present invention are explained. The first products P1 can be articles, services, or digital data, and also the second products P2 can be articles, services, or digital data. First, the product purchasing processes are explained. In case that the products are the digital data, the product purchasing processes are procedures from transmitting the order information to receiving the digital data. In case that the products are the articles or the services, the product purchasing process are procedures from transmitting the order information to receiving the articles, or to finishing the execution of the services.

The product ordering processes are explained. Regardless of the products are the articles, the services, or the digital data, the product ordering processes are procedures that the order information was transmitted to the seller server and the order information was received at the seller server.

The product delivering processes are explained. The product delivering processes are different among the types of the products. In case that the products are the digital data, based on the reception of the order information at the seller server, soon after finishing designated procedures at the seller server, the digital data are downloaded to the mobile terminal. In case that the products are the articles or the services, based on the reception of the order information at the seller server, the articles and the services are delivered to the destination designated by the user of the mobile terminal.

In case that the products are the articles or the services, delivering the articles (services) to the user and collecting the amount of money of the articles (services) from the user are not the concept of the present invention and executed by other systems.

Next, a case, in which the first products P1 are the karaoke music data and the second products P2 are the ringing tone music data, is explained. The first products P1 and the second products P2, which are handled in the electronic purchasing system 100 at the first embodiment of the present invention, are sold by respective different sellers. However, the first products P1 and the second products P2 have some relation between them. The relation can be seen by the matching process with both of the first and second products P1 and P2.

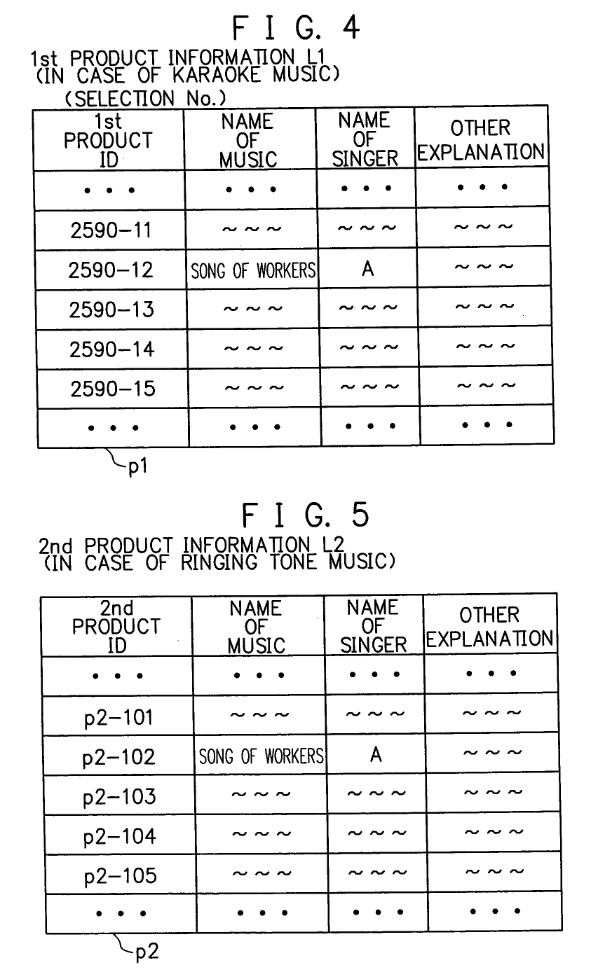

FIG. 4 is a table showing the first product information L1 of the first products P1 (karaoke music data) at the electronic purchasing system 100 of the first embodiment of the present invention. FIG. 5 is a table showing the second product information L2 of the second products P2 (ringing tone music data) at the electronic purchasing system 100 of the first embodiment of the present invention.

The relation between the first products P1 and the second products P2 is executed by the matching process with the first and second products P1 and P2, and the relation table R between the first products P1 and the second products P2 is made and held in the system. The relation table R can be held either in the first seller system 10 or the second seller system 20. At the first embodiment of the present invention, it is assumed that the relation table R is held in the first seller system 10.

The relation table R can be made by computer information processing, however, the relation table R can be also made by manual operation.

There are two cases that the relation table R is made. That is, one case is that the relation table R is made beforehand and is held either in the first seller system 10 or the second seller system 20. The other case is that the relation table R is made at each time when a user purchased a product. Either one of cases can be used.

At the first embodiment of the present invention, it is assumed that the relation table R has been made beforehand and has been held in the first seller system 10. And when a user purchased a first product P1, the relation table R is referred to, and the order sheet data N is made based on the information in the relation table R. In the order sheet data N, in which the first product purchased record T1′ of the user himself/herself and the second product information L2′ of the second products P2 relating to the purchased first product P1 were written.

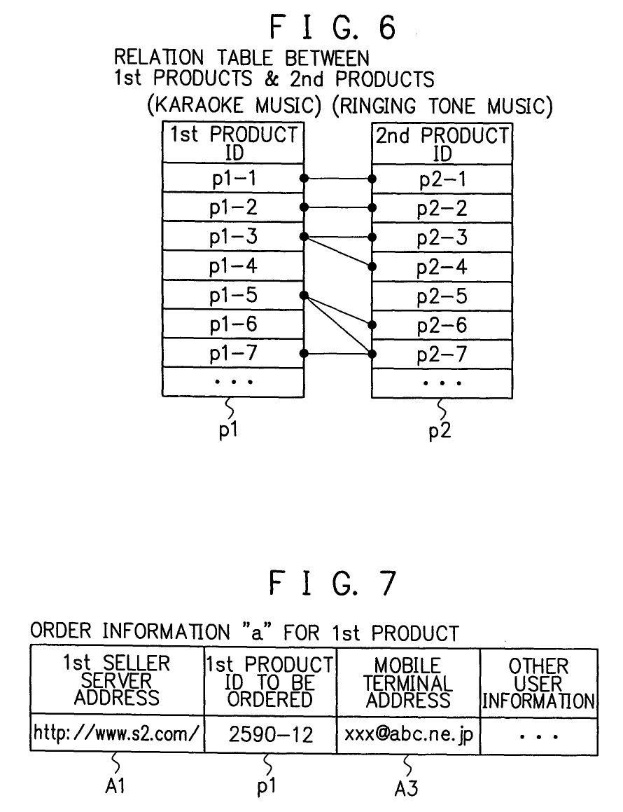

FIG. 6 is a diagram showing the relation table R between the first and second products P1 and P2 at the electronic purchasing system of the first embodiment of the present invention. In FIG. 6, each of the first products P1 is shown by an independent ID (identifier) such as p1-1, p1-2, p1-3, . . . , and also each of the second products P2 is shown by an independent ID such as p2-1, p2-2, p2-3. Further, each of the relation between them is shown by a link line. The form of the relation table R is not limited to the diagram shown in FIG. 6, and any form can be used. The relation is not limited to one-to-one relation, in some cases, one of the first products P1 may relate to plural second products P2, and plural first products P1 may relate to one of the second products P2, or there may be a case that some products have no relation.

At the electronic purchasing system 100, when a user ordered one of the first products P1 from the first seller system 10 by operating the mobile terminal 30 of the user, and purchased one of the first products P1, the first seller system 10 records the purchased result of the first product P1 in the first product purchased record T1 as a purchased history. And the order sheet data N, in which the first product purchased record T1′ of the user himself/herself and the second product information L2′ of the second products P2 relating to the purchased first product P1 were written, are formed at the first seller system 10. And this order sheet data N is transmitted to the mobile terminal 30 of the user.

From the viewpoint of the user, the purchased record information (purchased history and its detailed information) relating to the purchased products P1 is delivered to the user, this can be said the service is expanded at the first product selling service. Further, the user can obtain the second product information L2′ of the second products P2 relating to the purchased first products P1, and this process is a product information offering process (advertisement process) of the second products P2.

In this case, in which the karaoke music data and the ringing tone music data are offered to the users, based on the purchased result of the karaoke music data by the user, the purchased result is recorded in the first product purchased record T1 in the first seller system 10. Further, the order sheet data N, in which the first product purchased record T1′ of the user himself/herself and the second product information L2′ of the second products P2 (ringing tone music data) relating to the purchased first products P1 (karaoke music data) were written, are formed at the first seller system 10. And this order sheet data N is transmitted to the mobile terminal 30 of the user.

The address information A3 being the address information of the mobile terminal 30 is, for example, the e-mail address of the mobile terminal 30 of the user. And this address information A3 is information that identifies the mobile terminal 30 uniquely and is an ID (identifier) in the electronic purchasing system of the present invention. Further, this address information is used as the destination of the user when the order sheet data N is transmitted from the first seller system 10 to the mobile terminal 30. This address information A3 is transmitted to the first seller system 10 from the mobile terminal 30 of the user, when the product ordering process for the first product(s) P1 is executed from the mobile terminal 30 to the first seller system 10. That is, the address information A3 is transmitted to the first seller server S1 in the first seller system 10 in a state that the address information A3 was written in the first product order information “a”, or is transmitted at the same time when the first product order information “a” is transmitted.

Referring again to FIG. 3, the processes of the electronic purchasing system 100 at the first embodiment of the present invention are explained in more detail.

First, at the process (1), the user of the mobile terminal 30 executes an ordering process of the first product P1 to the first seller server S1 in the first seller system 10, by operating the mobile terminal 30. By this process, the order information “a” for purchasing the first product(s) P1 is transmitted to the first seller server S1 in the first seller system 10 from the mobile terminal 30. FIG. 7 is a table showing the order information “a” for the first product(s) P1 at the electronic purchasing system of the first embodiment of the present invention. As shown in FIG. 7, the order information “a” includes at least the ID (identifier) p1-x of each of the first products P1, the address information A3 of the mobile terminal 30 of the user, and the order quantity. Generally, the karaoke music is ordered one by one, therefore, when the order quantity is not inputted, the order quantity is judged as one. And the address A1 of the first seller system 10 (first seller server S1) and the other user information can be included in the order information “a”. In this, before the ordering process of the first product P1, the user of the mobile terminal 30 views the first product information L1 by displaying the information and selects one of the first products P1, and orders the first product P1. This process can be added. In FIG. 7, as the ID of the first product(s) P1, the selection number of the karaoke music data is shown.

The address information A3 of the mobile terminal 30 is address information, which is mainly used at the time when the order sheet data N is transmitted to the mobile terminal 30 from the first seller server S1 in the first seller system 10. And at the other processes such as a transmitting process of the order information “a” for the first product(s) P1 and a transmitting process of the order information “b” for the second product(s) P2 in the electronic purchasing system 100, address information of source address and destination address requiring in the corresponding communication protocol using at the other processes is used.

Next, at the process (2), based on the receiving process of the order information “a” (order receiving process) at the first seller server S1, the product delivering process of the ordered first product(s) P1 is executed to the mobile terminal 30. In case that the product is digital data, a digital data transmitting process is executed, in case that the product is an article, an article delivering process is executed, and in case that the product is a service, a designated service process is executed.

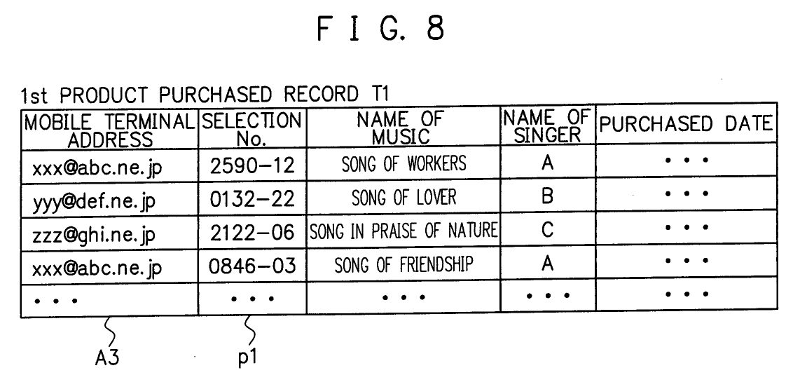

And at the process (3), the information of the purchased result of the first product(s) P1 by the mobile terminal 30 is recorded in the first product purchased record T1 in the first seller system 10. FIG. 8 is a table showing the first product purchased record T1 of the first products P1 (karaoke music data) at the electronic purchasing system of the first embodiment of the present invention. As shown in FIG. 8, the purchased information of the products P1 is shown in each of the users with the purchased date. In FIG. 8, the address information A3 of each of the users, the purchased first product P1 (selected music) with the selection number (the product ID p1-x) and the name of the music and the name of the singer, and the purchased date are shown. It is possible that this recording process is executed at the timing when the first seller system 10 received the order.

At the process (4), after the mobile terminal 30 of the user purchased the first product(s) P1, at the designated timing (after a designated period passed or a designated number of the first products P1 were purchased), the relation between the first products P1 and the second products P2 is made. That is, referring to the first product purchased record T1 (the first product purchased record T1′ of each of the users) and the relation table R between the first products P1 and the second products P2 and the second product information L2 (the second product information L2′ of each of the users), the relation between the purchased first products P1 and the second products P2 relating to the purchased first product P1 is made. In case that the relation table R has been made beforehand, the relation between the purchased first product(s) P1 and the second products P2 relating to the purchased first product(s) P1 can be made referring to the relation table R. In case that the relation is made arbitrarily after the first product(s) P1 was purchased, a product relation process is newly executed.

And the order sheet data N, in which the first product purchased record T1′ of the user himself/herself and the second product information L2′ of the user himself/herself relating to the purchased first product(s) P1 were written, are formed. The order sheet data N are formed in a format such as a designated markup language format and an e-mail+attaching file format. The first seller system 10 can make the second product information L2′ of each of the users, by obtaining the second product information L2 beforehand from the second seller system 20. In the order sheet data N, internal information, in which a process for issuing the order information “b” for purchasing the second product(s) P2 by selecting and clicking an item of the second products P2 is designated, is written.

And at the process (5), the first seller system 10 transmits the order sheet data N to the mobile terminal 30 of the user by using the address information A3 as its destination address. At the transmitting process of the order sheet data N, a designated communication protocol corresponding to the format of the order sheet data N is used. For example, in case that the order sheet data N are formed in the e-mail+attaching file format, the e-mail address of the user is used as the address information A3, and at the transmitting process, a designated e-mail protocol is used. The mobile terminal 30 stores the order sheet data N, received by the radio communication function of the mobile terminal 30, in a memory.

At the process (6), a displaying process is applied to the order sheet data N, which were received from the first seller system 10 and stored in the memory, on the display of the mobile terminal 30 by the user operation, and the user views the order sheet data N. The order sheet data N have display information and internal information that is not displayed. And as the display information, the first product purchased information T1′ and the second product information L2′ are displayed. These two pieces of information can be displayed as one combination at the same time, or can be displayed separately on the different screen. The user can confirm the purchased first product(s) P1 and also can view the second product information L2′ of the second products P2 relating to the purchased first product(s) P1. In case that an item(s), which the user wants to purchase, exists in the second product information L2′, the user executes a simple process selecting the item(s) and deciding its purchase at the mobile terminal 30.

At the process (7), when the user selected the item(s) of the second products P2, which the user wanted to purchase and operated the decision of the purchase, the mobile terminal 30 issues the order information “b” for purchasing the second product(s) P2, based on the information in the order sheet data N. And the mobile terminal 30 transmits the order information “b” to the second seller server S2 in the second seller system 20. In the order sheet data N, the address information A2 of the second seller server S2 and the ID information p2-x of each of the second products P2 are written as internal information. Further, the issuing and transmitting processes of the order information “b” are instructed in the order sheet data N, therefore, the user executes the processes by the instruction.

At the process (8), the second seller server S2 in the second seller system 20 executes the order receiving process by receiving the order information “b” from the mobile terminal 30, and executes the product delivering process for delivering the second product P2 to the mobile terminal 30.

At the process (9), at the second seller system 20, the purchased result of the second product(s) P2 by the mobile terminal 30 is recorded in the second product purchased record T2. The information such as the purchased product information identified by the product ID in the second products P2 and the purchased date is recorded. This recording process can be executed at the timing when the order information “b” was received.

At the process (10), the second seller system 20 confirms the sales state of the second products P2 by referring to the information in the second product purchased record T2 at a designated timing. And the second seller system 20 calculates the amount of the commission to be paid to the first seller system 10 based on a designated basis such as the sales result of the second products P2. And the second seller system 20 transmits commission payment information “c” including the information of the amount of the commission to be paid to the first seller system 10. The first seller system 10 executes a confirming process to confirm that the amount of the commission was paid normally, based on the received commission payment information “c”. The processes at the electronic purchasing system at the first embodiment of the present invention are mentioned above.

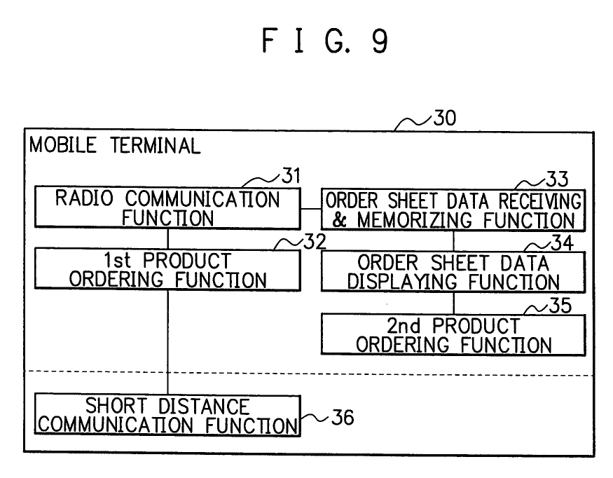

Next, each of the sections of which the electronic purchasing system 100 is composed is explained. First, the mobile terminal 30 is explained in detail. FIG. 9 is a block diagram showing the structure of the mobile terminal 30 in the electronic purchasing system 100 at the first embodiment of the present invention.

As shown in FIG. 9, the mobile terminal 30 provides a radio communication function 31, a first product ordering function 32, an order sheet data receiving and memorizing function 33, an order sheet data displaying function 34, and a second product ordering function 35. Further, the mobile terminal 30 provides a controlling and processing unit such as a CPU, memory devices such as ROMs and RAMs, an inputting means such as a key input unit, an outputting means such as a display and a speaker, an antenna, and a radio communication processing circuit, however, these are not shown in FIG. 9. The functions shown in FIG. 9 are controlled by program control. In FIG. 9, a short distance communication function 36 is used at another embodiment.

The mobile terminal 30 executes speech communication with other mobile terminal 30 through the radio communication function 31 in case that the mobile terminals 30 are mobile communication terminals. Further, it is possible that the mobile terminal 30 refers to the Web information by data communication through the radio communication function 31, and receives and transmits e-mails through the radio communication function 31. At the communication process between the mobile terminal 30 and the first seller server S1 or the second seller server S2, the radio communication function 31 is used.

The first product ordering function 32 is a function that executes the process ordering the first product(s) P1 from the first seller system 10. When the mobile terminal 30 orders the first product(s) P1, the first product ordering function 32 issues the order information “a” for the first product(s) P1 to the first seller server S1. At this time, the order information “a” includes the address information A3 of the mobile terminal 30. When the order sheet data N are transmitted from the first seller system 10 to the mobile terminal 10 later, this address information A3 of the mobile terminal 30 is used.

The order sheet data receiving and memorizing function 33 receives the order sheet data N transmitted from the first seller system 10 through the radio communication function 31, and memorizes and manages the received order sheet data N. The data receiving process corresponds to the form of the order sheet data N. It is possible that the order sheet data N memorizing in the memory is displayed on the display in the mobile terminal 30 by the user operation. The order sheet data receiving and memorizing function 33 can memorize plural order sheet data Ns. The user of the mobile terminal 30 can view the order sheet data N at his/her desiring timing, and when the user does not want to view them, it does not need to view them. Further, the order sheet data receiving and memorizing function 33 is able to have a function that deletes the order sheet data N by the user operation. When the deletion of the order sheet data N is instructed by the user, the order sheet data receiving and memorizing function 33 deletes the instructed order sheet data N in the memory.

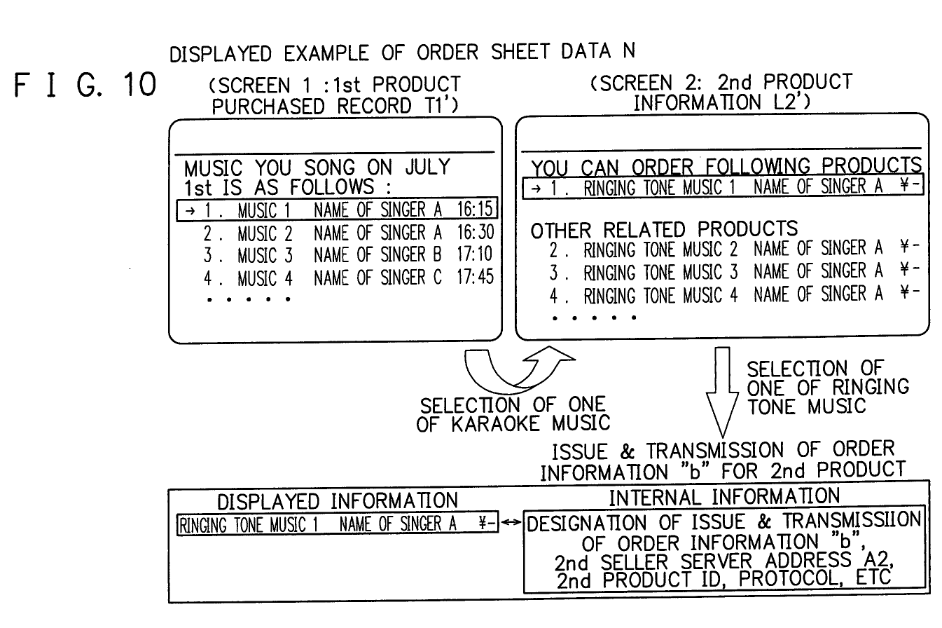

The order sheet data displaying function 34 displays the order sheet data N transmitted from the first seller system 10 on the display of the mobile terminal 30 by the user operation. In case that the mobile terminal 30 holds plural order sheet data Ns, it is possible that the order sheet data displaying function 34 displays one of the plural order sheet data Ns by the user selection. FIG. 10 is a diagram showing a displayed example of the order sheet data N on the display of the mobile terminal 30 at the first embodiment of the present invention. As shown in FIG. 10, as the order sheet data N, the product purchased record T1′ of the first products P1, the second product information L2′ relating to the purchased first Products P1, are displayed on the display of the mobile terminal 30, by the designated form based on the structure of the order sheet data N.

When the order of one of the second products P2 on the display of the mobile terminal 30 is selected in the order sheet data N on the display and the order of the selected second product P2 is decided by the user, the second product ordering function 35 issues the order information “b” of the decided second product(s) P2 with the internal information of the order sheet data N. And the second product ordering function 35 transmits the order information “b” to the second seller server S2 in the second seller system 20 via the radio communication function 31. The order information “b” of the second product P2 has a format, which can access the second seller system 20, such as the e-mail format and an HTTP format. The order information “b” is transmitted corresponding to the data format. In the order sheet data N, as the internal information being not displayed, the address information A2 of the second seller server S2, the product ID p2-x of the second product P2, and the address information A1 of the first seller server S1 (for confirmation). Further, in the order sheet data N, process instruction information, which instructs the processes executing by the mobile terminal 30, is described in each item of the products. Therefore, the mobile terminal 30 issues the order information “b” for the selected second product(s) P2 based on the information mentioned above.

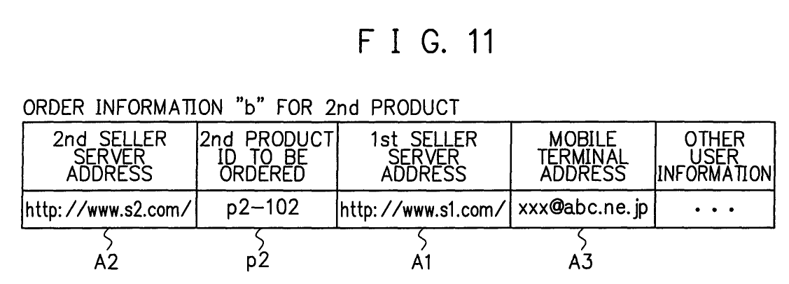

FIG. 11 is a table showing the order information “b” for the second product(s) P2 at the electronic purchasing system of the first embodiment of the present invention. As shown in FIG. 11, in the order information “b” of the second product P2, the address information A2 of the second seller server S2, the product ID p2-x of the second product P2, and the address information A1 of the first seller server S1 for confirmation, the address information A3 of the mobile terminal 30, which is referred by the second seller server S2 for delivering the second product P2, and other information such as the message of the user and the user information are included.

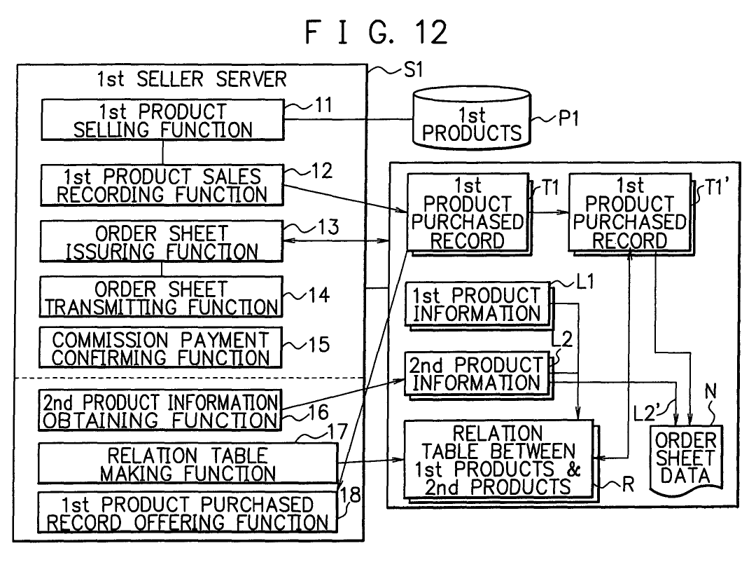

FIG. 12 is a block diagram showing the structure of the first seller server S1 in the first seller system 10 of the electronic purchasing system 100 at the first embodiment of the present invention.

As shown in FIG. 12, the first seller server S1 provides a first product selling function 11, a first product sales recording function 12, an order sheet issuing function 13, an order sheet transmitting function 14, and a commission payment confirming function 15. In FIG. 12, the functions below the dotted line are used at another embodiment of the present invention.

The first product selling function 11 is a function executing the sales of the first products P1, and receives the access of the order of the first products P1, and receives the order information “a”. And the first product selling function 11 delivers the ordered first product(s) P1 corresponding to the types of the products to the mobile terminal 30 based on the order information “a”. In case that the first product P1 is digital data, the first product P1 is downloaded to the mobile terminal 30. The first products P1 in FIG. 12 include a group of information regarding the selling procedures.

The first product sales recording function 12 is a function that records the information of the purchased result (sales result) of the first product(s) P1 by the user in the first product purchased record T1. As mentioned above, in FIG. 8, the information of the first product purchased record T1 is shown. As shown in FIG. 8, the purchased information of the products P1 is shown in each of the users with the purchased date. As shown in FIG. 8, the address information A3 of each of the users, the purchased first products P1 (selected music) with the selection number (the product ID p1-x) and the name of the music and the name of the singer, and other information such as the purchased date are recorded at the time when the users purchased the first products P1.

In the table of the first product purchased record T1, the purchased record of the first products P1 by all the users are recorded, and the purchased record is added at each time when one of the users purchased the one of the first products P1. This first product purchased record T1 can be said to be the history information of the first product sales information at the first seller system 10. In this, the ID of each of the first products is shown by its selection number.

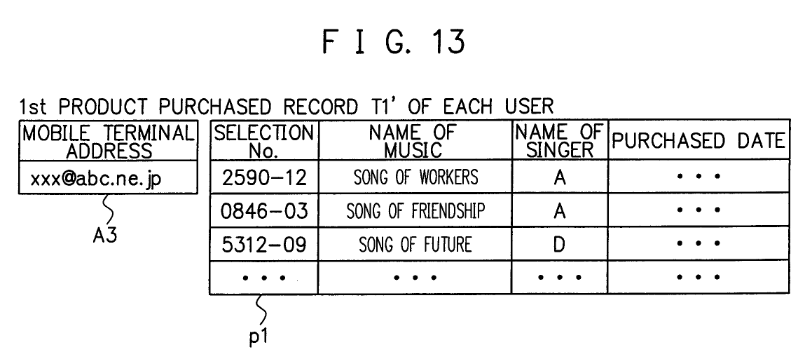

FIG. 13 is a table showing the first product purchased information T1′ of the first products P1 by each of the users at the electronic purchasing system of the first embodiment of the present invention. The first product purchased information T1′ is used to describe the first product purchased result of each user in the order sheet data N. The first product sales recording function 12 holds the first product purchased information T1 and T1′ in the first seller system 10.

The first product purchased information T1′ of each of the users can be extracted from the first product purchased information Ti. As shown in FIG. 13, the address information A3 of the user, the purchased first products P1 (selection numbers), the names of the music, the names of the singers, and other information such as the purchased dates are recorded. When the first product purchased record T1′ is delivered to the user, the information is arranged by a designated basis such as the date of the purchase, and the arranged information is delivered. In this, it is possible that the first product purchased record T1′ is made from the first by not making first product purchased information T1.

The order sheet issuing function 13 is a function that issues the order sheet data N at the designated timing. The order sheet data N is issued in a designated order sheet data form (template) by referring to the first product purchased record T1 (T1′), the relation table R, and the second product information L2. The order sheet data N includes the display information that combined the first product purchased record T1′ of each of the users and the second product information L2′ relating to the first product purchased record T1′. Further, the order sheet data N includes the internal information not being displayed such as the address information A2 of the second seller server S2, the address information A1 of the first seller server S1 (for confirmation), the second product ID p2-x, and information instructing the mobile terminal 30.

The order sheet transmitting function 14 is a function that transmits the order sheet data N issued at the order sheet issuing function 13 to the mobile terminal 30 by using the address information A3 of the mobile terminal 30. At this time, a designated communication protocol is used.

The commission payment confirming function 15 is a function for confirming whether the amount of the payment of the commission was paid normally or not from the second seller system 20. The commission payment confirming function 15 memorizes the commission payment information “c” by receiving it, and confirms the amount of the payment of the commission including in the commission payment information “c”. Further, the commission payment confirming function 15 memorizes the copy of the order information “b” by receiving from the second seller server S2, therefore, the commission payment confirming function 15 confirms the amount of the payment of the commission by also using the order information “b”. In this, the order information “b” for the second product(s) P2 to the second seller server 20 is also transmitted to the first seller system 10 at the same time when the mobile terminal 30 transmits the order information “b” to the second seller server S2.

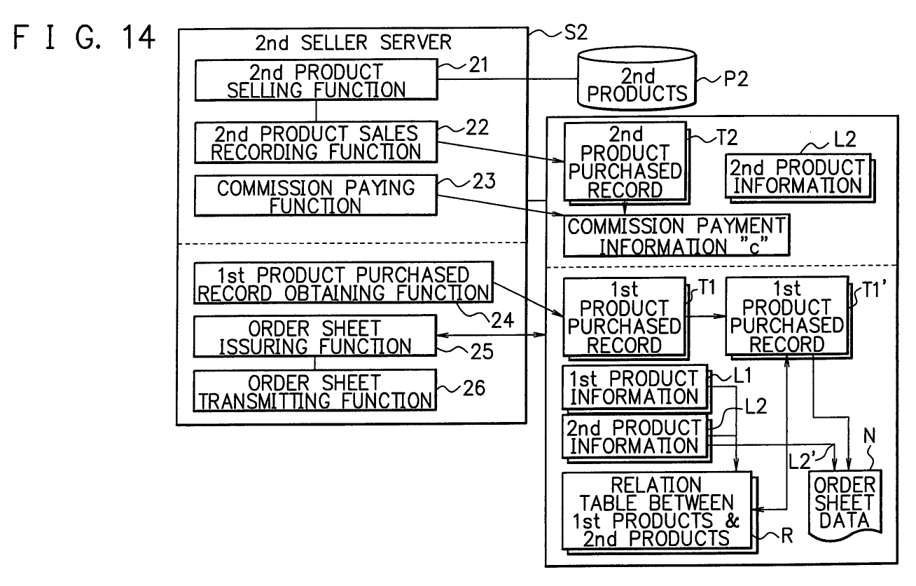

FIG. 14 is a block diagram showing the structure of the second seller server S2 in the second seller system 20 of the electronic purchasing system 100 at the first embodiment of the present invention.

As shown in FIG. 14, the second seller server S2 provides a second product selling function 21, a second product sales recording function 22, and a commission paying function 23. In FIG. 14, the functions below the dotted line, a first product purchased record obtaining function 24, an order sheet issuing function 25, and an order sheet transmitting function 26, are used at a third embodiment of the present invention.

The second product selling function 21 is a function executing the sales of the second products P2, and receives the access of the order of the second products P2, and receives the order information “b”. And the second product selling function 21 delivers the ordered second product(s) P2 corresponding to the types of the products to the mobile terminal 30 based on the order information “b”. In case that the second product P2 is digital data, the second product P2 is downloaded to the mobile terminal 30.

The second product sales recording function 22 is a function that records the information of the purchased result (sales result) of the second product P2 by the user in the second product purchased record T2. In the second product purchased record T2, the address information A3 of each of the users, the purchased second product(s) P2 with the product ID p2-x with (in case of the ringing tone music: the name of the music and the name of the singer), and other information such as the purchased date are recorded at the time when the users purchased the second products P2.

The commission paying function 23 calculates the amount of the commission to be paid to the first seller system 10 referring to the second product purchased record T2, and transmits the commission payment information “c” including the amount of the commission to the first seller system 10. The amount of the commission is calculated at the designated timing based on the designated basis. For example, the sales result of the second products P2 is the calculation basis. The collection of the money for the sales of the second products P2 is executed by a designated collection settlement means.

As shown in FIG. 4, in the table of the first product information L1 of the first products P1, in each of the first products P1, the first product ID, text information such as the name of the product, and other information explaining the first product P1 in detail are described. For example, in case that the first products P1 are the karaoke music, the first product information L1 includes the text information such as the name of the music and the name of the singer. It is possible that the first product information L1 is formed by a multi media form in which image data are included in addition to the text information. The first product information L1 and the second product information L2 are information that are referred to for making the relation table R between the first and second products P1 and P2. However, other information, instead of the first product information L1, can be used, when the other information includes the other necessary information.

As shown in FIG. 5, in the table of the second product information L2 of the second products P2, in each of the second products P2, the second product ID, text information such as the name of the product, and other information explaining the second product P1 in detail are described. For example, in case that the second products P2 are the ringing tone music, the second product information L2 includes the text information such as the name of the music and the name of the singer. It is possible that the second product information L2 is formed by a multi media form in which image data are included in addition to the text information. At the first seller system 10, the second product information L2′ of each of the users is formed based on the second product information L2. And this second product information L2′ is described in the order sheet data N.

At the example of the first and second product information L1 and L2 mentioned above, the names of the music and the names of the singers are included in both the information. Therefore, the same word can be found by applying the matching process to both the first and second product information L1 and L2. With this, the relation table R can be made.

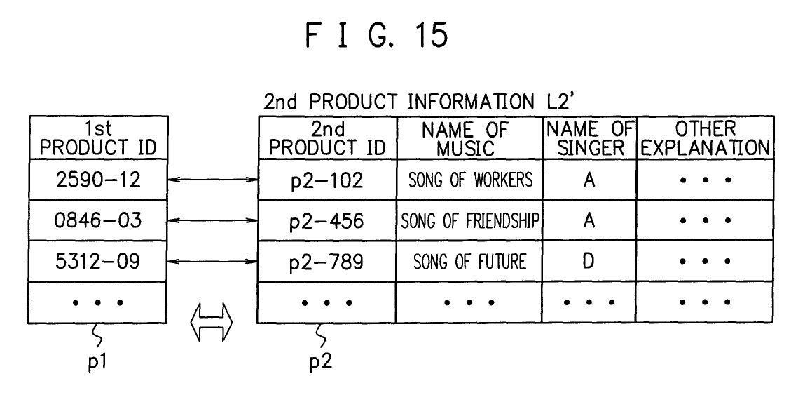

FIG. 15 is a table showing the second product information L2′ of the second products P2 in each of the users at the electronic purchasing system of the first embodiment of the present invention. The second product information L2′ of each of the users is the product information of the second products P2 relating to the first products P1 which the user purchased. The second product information L2′ can be made by extracting the information from the second product information L2 and by converting the extracted information. The second product information L2′ is made by referring to the first product purchased record T1′, the relation table R, and the second product information L2.

At the example shown in FIG. 15, the information of the second products P2 is shown by that the second product P2 is related with the first product P1 one by one. The second product information L2′ becomes the display information in the order sheet data N with the first product purchased record T1′. In its actual operation, the relation is limited to one by one relation, the relation can be made corresponding to the relation table R.

In FIG. 7, an example of the order information “a” for the first product P1 is shown. The order information “a” includes the address information A1 of the first seller server S1, the ID (identifier) p1-x of each of the first products P1, the address information A3 of the mobile terminal 30 of the user. And other information such as the message of the user can be included in the order information “a”. The address information A1 of the first seller server S1 is the information using at the time when the mobile terminal 30 accesses the first seller server S1. The address information A3 of the mobile terminal 30 is the information using at the time when the first seller system 10 transmits the order sheet data N to the mobile terminal 30. Other address information is used corresponding to the communication protocol using between the first seller system 10 and the mobile terminal 30.

In FIG. 11, an example of the order information “b” for the first product P2 is shown. In the order information “b” of the second product P2, the address information A2 of the second seller server S2, the ID p2-xof the second product P2, and the address information A1 of the first seller server S1 for confirmation, the address information A3 of the mobile terminal 30, and other information such as the message of the user.

The address information A2 of the second seller server S2 is the information using at the time when the mobile terminal 30 accesses the second seller server 20. The address information A1 of the first seller server 10 is the information for confirmation, and electronic purchasing system 100 can confirm that the purchase of the product is based on this electronic purchasing system by this address information A1. The address information A3 of the mobile terminal 30 in the order information “b” is the source information of the order information “b” and is used when the ordered second product P2 is delivered to the mobile terminal 30 from the second seller system 20. Other address can be used corresponding to the communication protocol using between the mobile terminal 30 and the second seller system 20. Further, other information can be used corresponding to the communication protocol using between the mobile terminal 30 and the second seller system 20.

The order information “b” for the second product P2 is made by the designated form such as the e-mail form. At the first embodiment of the present invention, the order information “b” for the second product P2 is transmitted to the second seller server 20 from the mobile terminal 30 by using the e-mail form. However, a designated communication protocol such as the HTTP can be used.

The second seller system 20 executes the process delivering the second product P2 to the mobile terminal 30 by using the address information A3 of the mobile terminal 30, based on the reception of the order information “b”. In case that the second product P2 is digital data, the second seller system 20 downloads the second product P2 to the mobile terminal 30. And at the same time the order information “b” is transmitted to the first seller system 10 by using the address information A1. The first seller system 10 uses this order information “b” for the confirmation of the commission payment.

The first seller server 10 issues the order sheet data N by describing with a designated markup language. At the first embodiment of the present invention, the order sheet data N are transmitted by the e-mail protocol. The document structure of the order sheet data N is written by a designated grammar, and the markup information is written by tags. And as the internal information, the address information A2 of the second seller server S2 and the second product ID p2-x are written by relating with the first product purchased record T1′ and the second product information L2′.

Further, as the internal information, operation instructing information, which instructs the operation executing by the mobile terminal 30 at the time when a position or an item on the display information is decided by confirmation, is written by a designated element such as an anchor tag in the HTML. As the operation instructing information, for example, the protocol using for transmission of the order information “b” for the second product P2 (for example, e-mail protocol), and the address information A2 of the second seller server S2 are written. The following description is desirable. That is, the designated items such as the name of the product and the product item are written in the hyper link format in the display information on the order sheet data N. And when the link source position (text and image) is selected by a click, the order information “b” for the selected second product P2 is issued and transmitted.

At the order sheet data displaying function 34 in the mobile terminal 30 shown in FIG. 9, the order sheet data N received from the first seller system 10 are displayed by applied the sentence structure analysis. The order sheet data displaying function 34 detects tags by reading from the head of the order sheet data N, and applies processes corresponding to the process designated description for each of the tags. And the order sheet data displaying function 34 displays the display information such as the first product purchased record T1′ and the second product information L2′ of each of the users.

When an item of the second products P2 is decided by the user input operation on the display of the mobile terminal 30, the second product ordering function 35 issues the order information “b” for the decided second product P2, and the order information “b” is transmitted to the second seller server S2. At this time, the internal information described in the order sheet data N such as the address information A2 of the second seller server S2, the second product ID p2-x, the address information A1 of the first seller server S1, the address information A3 of the mobile terminal 30 itself, and other user information is transmitted with the order information “b”. In this, as the other user information, the information storing in the mobile terminal 30 can be used.

In FIG. 10, as mentioned above, a displayed example of the order sheet data N on the display of the mobile terminal 30 is shown. In this example, the first product purchased record T1′ and the second product information L2′ of each of the users are displayed on respective different screens. At the mobile terminal 30, when the order sheet data N is displayed by the analysis, corresponding to the sentence structure description of the order sheet data N, the page of the first product purchased record T1′ is displayed on the first screen. In this example, the information regarding the first products P1 that the user purchased (used) on a certain date is displayed in a list form. The first screen shows a case of the karaoke music delivering service, and the names of the music (music 1, music 2, . . . ), the names of the singers (name A, name B, . . . ) and the used time of each of the music, are shown on the first screen with the used date.

When some karaoke music is decided by the selection in the first product purchased record T1′ on the first screen, the second product information L2′ relating to the decided music is displayed on the second screen. In this, the selection of the music is executed by pushing an up and down key, or pushing a number key, and the decision is executed by pushing a decision key or a click on the screen. On the second screen, the second product information L2′ relating to the decided karaoke music is displayed. That is, the ringing tone music 1 relating to the karaoke music 1 is displayed with the price, and other related products (ringing tone music 2, 3, . . . ) are also displayed on the second screen with the price of each ringing tone music, because the singer is the same.

In this example, since the music is the same in the relation between the karaoke music 1 and the ringing tone music 1, the ringing tone music 1 is displayed at the first.

When some ringing tone music is decided by the user based on the message “You can order following products” in the second product information L2′, the mobile terminal 30 issues the order information “b” for the decided second product P2 based on the internal information describing in the order sheet data N, and transmits the order information “b” to the second seller server S2.

At the display of the order sheet data N on the mobile terminal 30, in order that the mobile terminal 30 can purchase plural second products P2, a selection form, in which the plural second products P2 can be selected, and a transmission form, in which the plural order information “b” can be transmitted, can be described on the order sheet data N as its display information. With this, the user of the mobile terminal 30 can order the plural second products P2 at the same time.

Further, at the display of the order sheet data N, after the decision of the purchase of the second product P2 by the user, reconfirmation information about the decision is displayed in a designated form. And when the user pushed the reconfirmation key, the order information “b” for the second product P2 is transmitted to the second seller server S2. The order sheet data N applying the reconfirmation process can be used. Further, at the product ordering process, the user authenticating process can be used.

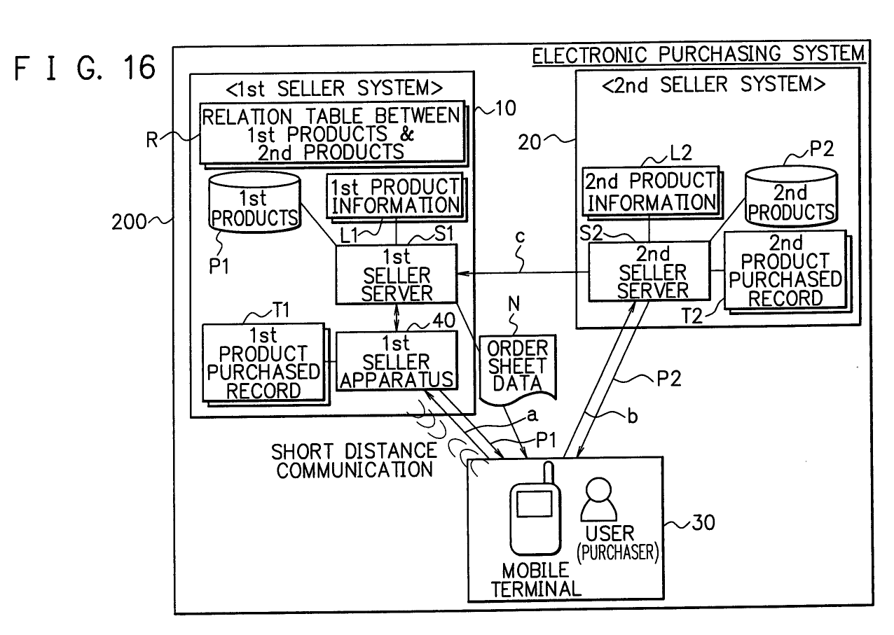

Next, the second embodiment of the present invention is explained. FIG. 16 is a block diagram showing the structure of an electronic purchasing system at a second embodiment of the present invention. As shown in FIG. 16, an electronic purchasing system 200 at the second embodiment of the present invention consists of a first seller system 10, a second seller system 20, and mobile terminals 30 of users (purchasers).

At the electronic purchasing system 200 at the second embodiment of the present invention, the first seller system 10 has the same reference number 10 as that at the first embodiment has, however, the first seller system 10 at the second embodiment provides plural first seller apparatuses 40 (plural first seller terminal apparatuses) additionally. And also the mobile terminal 30 has the same reference number 30 as that at the first embodiment has, however, the mobile terminal 30 additionally provides a short distance communication function 36 shown in FIG. 9. And the second seller system 20 is the same at both the first and second embodiments.

And the plural first seller apparatuses 40 connect to the first seller server S1 via a communication network, and each of the plural first seller apparatuses 40 is connected to each of the plural first product purchased records T1.

The mobile terminal 30 executes the order process of the first product(s) P1 by using the short distance communication function 36.

The short distance communication function 36 is a function that communicates with one of the plural first seller apparatuses 40 positioned near the mobile terminal 30 by using short distance communication. As the short distance communication function 36, radio communication means such as a means using an Infrared Data Association (IrDA) and a means using Bluetooth, and a wire communication means using a wire cable, are used.

The first seller apparatus 40 is installed at a designated position, and receives the order for the first product(s) Pl and delivers the ordered first product(s) P1. For example, in case that the first product(s) P1 is karaoke music, the first seller apparatus 40 is a communication karaoke apparatus, and plays some designated karaoke music.

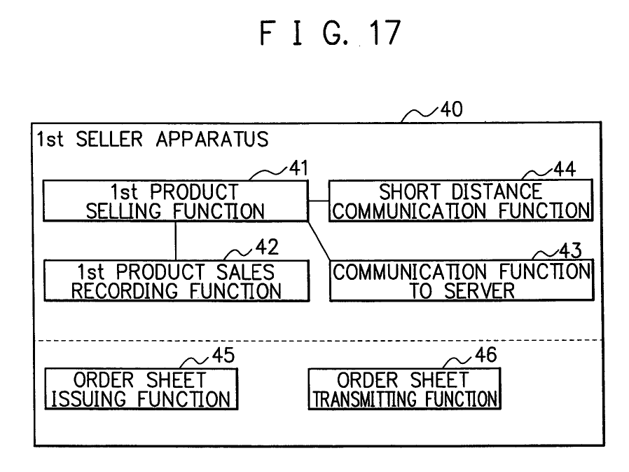

FIG. 17 is a block diagram showing the structure of the first seller apparatus 40 in the first seller system 10 of the electronic purchasing system 200 at the second embodiment of the present invention. The first seller apparatus 40 provides a first product selling function 41, a first product sales recording function 42, a communication function to server 43, and a short distance communication function 44. Further, the first seller apparatus 40 provides a controlling and processing unit such as a CPU, memory devices such as ROMs and RAMs, an inputting means, however, these are not shown in FIG. 17. Further, as shown in FIG. 17 below the dotted line, an order sheet issuing function 45 and an order sheet transmitting function 46 can be provided in the first seller apparatus 40.

The first product selling function 41 is a function that sells the first product(s) P1. The first product selling function 41 receives the order information “a” of the first product(s) from the mobile terminal 30 via the short distance communication function 44, and processes the received order information “a”. Further, the first product selling function 41 delivers the first product(s) P1 requested by the order information “a” to the mobile terminal 30. For example, the first product(s) P1 is karaoke music, the first product selling function 41 plays the karaoke music designated by the selection number (ID of the karaoke music). Depending on the types of the first products P1, it is possible that the first seller server S1 delivers the first products P1 to the mobile terminal 30.

The first product sales recording function 42 is a function that records the information of the first product(s) purchased by the user(s) in the first product purchased record T1. The information in the first product purchased record T1 is transmitted to the first seller sever S1 at designated timing via the communication function to server 43 and the first seller server S1 adds the information of the first product purchased records T1 from the plural first seller apparatuses 40. In this, it is possible that the first seller server S1 collects the information of the first product purchased records from the plural first seller apparatuses 40 and adds them. Further, the first product purchased record T1 can be managed by the first seller server S1 from the beginning, in this case, the plural first seller apparatuses 40 transmit the information of the first product purchased records to the first seller server S1 via the communication function to server 43 at each of the selling operation.

The communication function to server 43 is a function that communicates with the first seller server S1. The first seller apparatus 40 communicates with the first seller server S1 via the communication function to server 43, and executes functions and services regarding the sales of the first product(s) Pi. For example, the first product PI is a karaoke music delivering service, the first seller apparatus 40 downloads the karaoke music data via the first seller server S1. The first seller apparatus 40 transmits the information of the first product purchased record T1 to the first seller server S1 via the communication function to server 43, and receives the necessary information such as information delivering to the mobile terminal 30 from the first seller server S1.

The short distance communication function 44 is a function that communicates with the short distance communication function 36 in the mobile terminal 30, and receives the order information “a” for the first product(s) from the mobile terminal 30. And the first seller apparatus 40 delivers the ordered first product(s) P1 to the mobile terminal 30 via the short distance communication function 44. In case that the first product P1 is digital data, the digital data are transmitted to the mobile terminal 30 via the short distance communication function 44.

At the first seller system 10 in the electronic purchasing system 200, by using the communication processes between the first seller server S1 and the first seller apparatus 40, as the same processes as at the electronic purchasing system 100 at the first embodiment, the reception of the order information “a” for the first product(s) P1, the issue of the order sheet data N, and the delivery of the ordered first product(s) P1 to the mobile terminal 30 are executed. As mentioned above, the first product purchased record T1 can be held in each of the plural first seller apparatuses 40 or in the first seller server S1. And the issue of the order sheet data N can be executed in either the plural first seller apparatuses 40 or the first seller server S1. That is, corresponding to the process types, the transmission and the reception of the necessary information are executed between the first seller server S1 and the plural first seller apparatuses 40 by using the communication function to server 43. In case that the issue and the transmission of the order sheet data N are executed in the first seller apparatus 40, the first seller apparatus 40 provides the order sheet issuing function 45 and the order sheet transmitting function 46. In case that the order sheet data N is transmitted from the first seller apparatus 40, the order sheet data N is transmitted to the mobile terminal 30 by using the short distance communication function 44.

At the electronic purchasing system 200 at the second embodiment of the present invention, the user operates the mobile terminal 30 at the position near the first seller apparatus 40, and orders the first product(s) P1. The mobile terminal 30 orders the first product(s) P1 by using the first product ordering function 32 and the short distance communication function 36. At the second embodiment of the present invention, in the order information “a” shown in FIG. 7, the address information A1 becomes the address information of the first seller apparatus 40 instead of the address information of the first seller server S1. Corresponding to the order and the purchase of the first product(s) P1 by the mobile terminal 30, the first seller server S1 (or the first seller apparatus 40) issues the order sheet data N, and the first seller server S1 (or the first seller apparatus 40) transmits the order sheet data N to the mobile terminal 30. The processes after this are the same as those at the first embodiment.

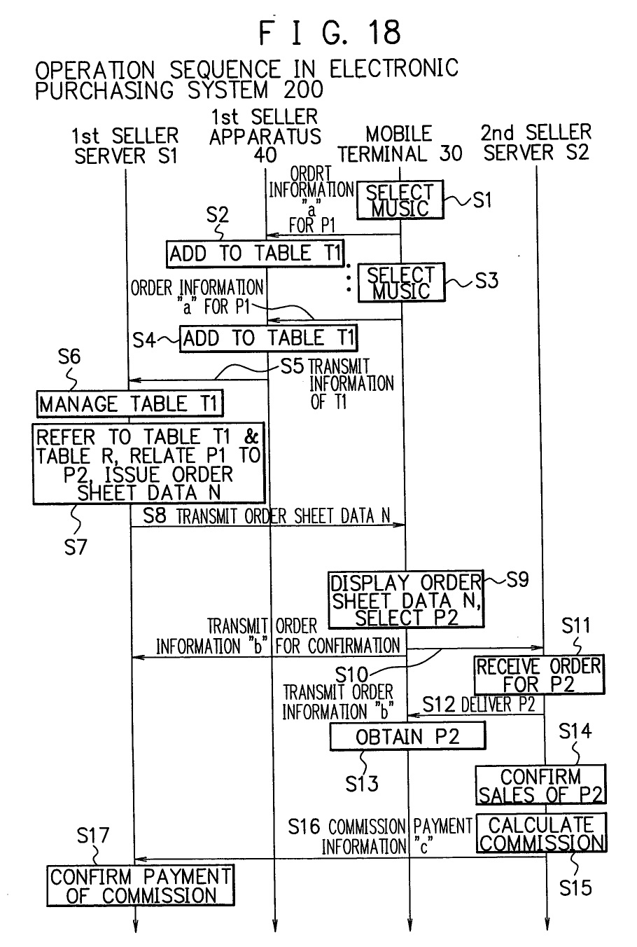

Next, the operation of the electronic purchasing system 200 at the second embodiment of the present invention is explained. FIG. 18 is a diagram showing an operation sequence of the electronic purchasing system 200 at the second embodiment of the present invention. At the explanation of this operation sequence, a case, in which the first product(s) P1 is the karaoke music delivering service and the second product(s) is the ringing tone music data, is used. That is, the first seller apparatus 40 is the communication karaoke apparatus, and the second seller server S2 is the server that delivers the ringing tone music data.

Referring to FIG. 18, the operation sequence of the electronic purchasing system 200 at the second embodiment of the present invention is explained. In FIG. 18, the reference numbers S1 and S2 are used for both the servers and the step numbers, however, the reference numbers S1 and S2 for the step numbers are distinguished by attaching the step number.

The user uses the karaoke delivering service by using the mobile terminal 30 of the user at the place where the first seller apparatus 40 (the communication karaoke apparatus) is installed. First, the user requests the first seller apparatus 40 to play his/her desiring music by operating the keys of the mobile terminal 30. That is, the user selects the desiring music by inputting the selection number (first product ID p1-x) of the desiring music on the keys of the mobile terminal 30 (step S1). Next, the order information “a” for the selected music is transmitted from the mobile terminal 30 to the first seller apparatus 40 via the first product ordering function 32 and the short distance communication function 36 of the mobile terminal 30. In the order information “a”, the information of the selection number of the music and the address information A3 of the mobile terminal 30 are included. Th first seller apparatus 40, which received the order information “a”, plays the selected music for the user. By the order information “a”, the information of the ordered first product P1 is recorded in the first product purchased record T1, and the address information A3 of the mobile terminal 30 is transmitted to the first server S1 (step S2).

At the step S2, the first seller apparatus 40 (communication karaoke apparatus) receives the order information “a” for the first product P1 (selected music) form the mobile terminal 30, and plays the ordered music by using the selection number in the order information “a”. With this, the mobile terminal 30 receives the karaoke music delivering service. The first seller apparatus 40 records the information of the first product P1 (played karaoke music) in the first product purchased record T1 as the purchased history. In the first product purchased record T1, as shown in FIG. 8, the address information A3 of the mobile terminal 30 for identifying the user, the selection number (the product ID p1-x), the name of the music, the name of the singer, and the purchased date are recorded.

The first seller apparatus 40 or the first seller server S1 stores the address information A3 of the mobile terminal 30 obtained from the order information “a”, as the information for issuing and transmitting the order sheet data N later.

Between the mobile terminal 30 and the first seller apparatus 40, the operation selecting the music is repeated several times by using the order information “a” (step S3 and step S4). And the first seller apparatus 40 plays the selected music.

The first seller apparatus 40 transmits the information of the first product purchased record T1 to the first seller server S1 at the designated timing by using the communication function to server 43 (step S5). And the first seller server S1 receives the first product purchased record T1 from the first seller apparatus 40, and adds the information of the first product purchased record T1 to the information of the other first product purchased records T1 transmitted from the other first seller apparatuses 40. And the added information of the first product purchased records T1 is managed by the first seller server S1 as the added first product purchased record T1 (step S6). In this, from the first product purchased record T1, the first product purchased record T1 of each of the users can be extracted.

After the user used the karaoke music delivering service, the first seller server S1 issues the order sheet data N at the designated timing. When the order sheet data N is issued, the first product purchased record T1 (T1′) and the relation table R are referred to, and the relation between the first product (s) P1 and the second product(s) is made (step S7). And in the order sheet data N, the first product purchased record T1′ of each of the users and the second product information L2′ relating to the first product purchased record T1′ are included as the display information. When the relation between the first product (s) P1 and the second product(s) has been made, this relation is not made at this time.

Further, at the time when the order sheet data N is issued, the first product purchased record T1, the second product information L2, the address information A3 of the mobile terminal, the address information A2 of the second seller server S2 are used as the description information. In the relation table R, the relation between the karaoke music and the ringing tone music has been made in 1:1, the ringing tone music corresponding to the karaoke music, which the user used, is selected.

The first seller server S1 transmits the order sheet data N by the e-mail form to the mobile terminal 30, by using the address information A3, which the first seller server S1 has already obtained in the order information “a” (step S8). In this, in case that the order sheet data N is transmitted from the first seller apparatus 40, the order sheet data N is transmitted through the short distance communication function 44.

At the explanation mentioned above, the first seller server S1 issued the order sheet data N, and the order sheet data N was transmitted from the first seller server S1 to the mobile terminal 30. In case that the first seller apparatus 40 provides the order sheet issuing function 45, the first seller apparatus 40 issues the order sheet data N, by referring the information such as in the first product purchased record T1 (T1′). And the issued order sheet data N is transmitted via the first seller server S1 or from the first seller apparatus 40 in case that the first seller apparatus 40 provides the order sheet transmitting function 46.

The mobile terminal 30 memorizes the order sheet data N by receiving at the order sheet data receiving and memorizing function 33. At the arbitrary timing of the user, the order sheet data N can be displayed on the display of the mobile terminal 30 by the order sheet data displaying function 34. The order sheet data N has a data form by which some ringing tone music data, which are described in the second product information L2′ being the display information, can be ordered by an easy operation of the user. The user views the first product purchased record T1′, which is the used history of the first product(s) (karaoke music) by the user himself/herself, and the can order some ringing tone music, which the user desires to obtain from the music that the user sang, by a simple operation of the user.

In case that some user desiring product(s) exists in the second product information L2′ in the order sheet data N on the display, the user selects the second product(s) and decides the purchase of the second product(s) (step S9). When the user decided the purchase of the second product(s), the order information “b” for the second product(s) is issued based on the internal information described in the order sheet data N, and the order information “b” is transmitted to the second seller server S2 (step S10). At the same time, the order information “b” is transmitted to the first seller server S1 for the process confirmation by using the address information A1. For example, the multi-destination function at the e-mail is used.

The first seller system 10 has instructed that the order information “b” is transmitted to the first seller server S1 at the same time when the order information “b” is transmitted to the second seller server S2. With this, the record, which the user wants to purchase the second product(s) P2 from the second seller system 20, is also held in the first seller system 10, therefore, the first seller system 10 can use the information for confirming the payment of the commission.

When the second seller server S2 received the order information “b” from the mobile terminal 30, the second seller server S2 executes the process of the reception of the order (step S11). And the second seller server S2 delivers the second product(s) P2 to the mobile terminal 30 (step S12). And the second seller server S2 records the information of the second product(s) purchased by the mobile terminal 30 in the second product purchased record T2.

The mobile terminal 30 obtains the ringing tone music data (second product(s)) P2 (step S13). The delivering the second product(s) is different among the types of the products. In case that the second product(s) is the digital data, the digital data are downloaded to the mobile terminal 30 by using the communication function of the second seller server S2. For example, the ringing tone music data are transmitted to the mobile terminal 30 by attaching an-email that informs the delivering of the second product(s) P2. The mobile terminal 30 receives the ringing tone music data and memorizes them in the memory, and makes the ringing tone music data work.

The second seller system 20 confirms the sales state of the second product(s) at the designated timing by referring to the second product purchased record T2 (step S14). And the second seller system 20 calculates the commission to be paid to the first seller at the commission paying function 23 in the second seller server S2 (step S15). The calculation of the commission is executed based on the designated basis by the contract between the first seller and the second seller made beforehand. And the commission paying function 23 transmits the commission payment information “c” to the first seller system 10 (step S16). For example, the second seller system 20 calculates the number of sales products P2 by referring to the second product purchased record T2 and the address information A1 of the first seller server S1, and pays the commission to the first seller system 10.

The first seller system 10 receives the commission payment information “c” and confirms whether the payment of the commission is executed normally or not (step S17). At the confirmation of the payment, the order information “b” for the second product(s) P2, which has been stored by receiving from the mobile terminal 30, is also referred to. By using both of the information, the first seller system 10 can confirm whether the payment of the commission was executed based on the designated basis or not.

At the second embodiment of the present invention, the mobile terminal 30 is used as a selection unit for selecting some karaoke music, that is, the mobile terminal 30 is used for ordering the first product(s) P1. By using the mobile terminal 30 for selecting the karaoke music, the information such as the address information A3 of the mobile terminal 30 is transmitted to the first seller system 10, and this information is used for the processes such as the process transmitting the order sheet data N to the mobile terminal 30.

At the communication karaoke system, the user selects some music by using the selection unit, and the first seller apparatus (communication karaoke apparatus) 40 transmits the music to a karaoke entertainment shop where the user exists, and the user sings the song along with the transmitted music. This system is existing.

At the electronic purchasing system 100 at the first embodiment and the electronic purchasing system 200 at the second embodiment, the copy of the second product information L2, which is the information of the second product(s) P2 to be delivered by the second seller, is held in the first seller system 10. By using this information, the relation table R between the first products P1 and the second products P2 is made.

It is not necessary that the product ID is composed of some English letters and numbers, and it is possible that the product ID is made in a text form in which the name of music and the name of singer are combined. That is, it is enough that the product ID is information by which the product is identified uniquely.

Further, the first seller system 10 and the second seller system 20 can provide plural servers corresponding to the function of them.

At the second embodiment of the present invention, the order sheet data N is transmitted from the first seller server S1 to the mobile terminal 30 by using the e-mail address and the e-mail protocol. However, the order sheet data N is held in the first seller server S1 (the first seller system 10), and when the mobile terminal access the first seller server S1, the order sheet data N is transmitted to the mobile terminal 30. This structure is also possible. In this case, it is necessary that the mobile terminal 30 access the first seller server S1 by using the address information A1 of the first seller server S1. When the user wants to view the first product purchased record T1′, the user accesses the first seller server S1 by using the mobile terminal 30, and the mobile terminal 30 obtains the order sheet data N, and the user views the information in the order sheet data N on the display.

Further, the information of the user such as the address information A3 of the mobile terminal 30 has been registered in the first seller system 10 beforehand, and the processes are executed by using this information. This structure is also possible. In this case, it is not necessary that the mobile terminal 30 transmits the order information “a” for the first product(s) P1 with the address information A3 of the mobile terminal 30. When the order sheet data N are transmitted by issuing, the user information including the address information A3, registered in the first seller system 10, are referred to.

Further, in case that the user purchased plural first products P1 through the first seller system 10, plural second products P2 relating to the plural first products P1 are described in the order sheet data N, which are transmitted from the first seller server S1 or the first seller apparatus 40, and the user selects one or plural second products P2 from the information in the order sheet data N. This form of the order sheet data N is possible.

At the embodiments mentioned above, the case, in which the first product(s) P1 is karaoke music and the second product(s) P2 is ringing tone music, is explained. In the relation of the music, there are other products such as tickets for concerts, music media such as CDs and DVDs, music data in a digital form that are delivered via a network, the information relating to singers, the information relating to the contents of music. The electronic purchasing system at the embodiments of present invention can be applied to these music products. Further, even without the products relating to the music, the electronic purchasing system at the embodiments of the present invention can be applied to products that relate with each other.

Moreover, in case that plural second sellers, which handle the same kinds of products, exist, for example, plural ringing tone music data sellers exist, these plural second sellers make contracts with the first seller in the electronic purchasing system. In this case, plural second products by the plural second sellers are related to the first products.

Furthermore, in case that plural second sellers (second seller to “n”th seller), which handle the different kinds of products, exist, these plural second sellers make contracts with the first seller in the electronic purchasing system. In this case, plural second products by the plural second sellers are related to the first products. In the order sheet data N, the first product purchased record T1′ of each of the users, the second product information L2′ to Ln′ of the plural second products P2 to Pn, which relate with the first products P1, are described as the display information. In case that some product(s), which the user wants to purchase, exists in the second product information L2′ to Ln′, the user selects and decides the product(s) by operating the mobile terminal 30, with this, the order information about the second product(s) is issued, and the second product(s) are delivered to the user.

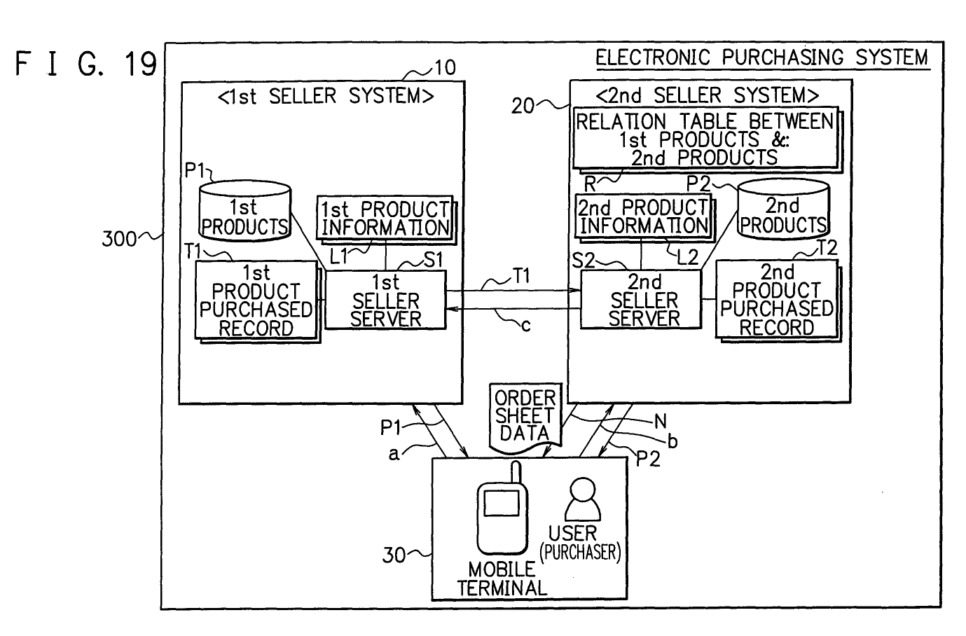

Next, the third embodiment of the present invention is explained. FIG. 19 is a block diagram showing the structure of an electronic purchasing system at a third embodiment of the present invention. As shown in FIG. 19, an electronic purchasing system 300 at the third embodiment of the present invention consists of a first seller system 10, a second seller system 20, and mobile terminals 30 of users (purchasers). That is, the basic structure at the third embodiment is the same that at the first and second embodiments.

At the electronic purchasing system 100 of the first embodiment and at the electronic purchasing system 200 of the second embodiment of the present invention, the first seller system 10 holds the copy of the second product information L2, and makes the relation table R between the first products P1 and the second products P2. However, at the electronic purchasing system 300 of the third embodiment of the present invention, the second seller system 10 holds the second product information L2, and makes the relation table R between the first products P1 and the second products P2. Further, the order sheet data N are issued by the second seller system 20 instead of by the first seller system 10.

At the electronic purchasing system 300 of the third embodiment of the present invention, as shown in FIG. 14, the second seller system S2 in the second seller system 20 provides the first product purchased record obtaining function 24, the order sheet issuing function 25, and the order sheet transmitting function 26.

The first product purchased record obtaining function 24 is a function that obtains the first product purchased record T1 (T1′) from the first seller system 10 at the designated timing via a network, and stores it in a memory. The first product purchased record obtaining function 24 also obtains the address information A3 of the mobile terminal 30 that is necessary to transmit the order sheet data N to the mobile terminal 30 of the user. This can be said that the first seller system 10 provides the first product purchased record offering function 18, which offers the first product purchased record T1 to the second seller system 20, shown in FIG. 12.

The order sheet issuing function 25 is a function that issues the order sheet data N, and the order sheet transmitting function 26 is a function that transmits the issued order sheet data N to the mobile terminal 30 of the user.

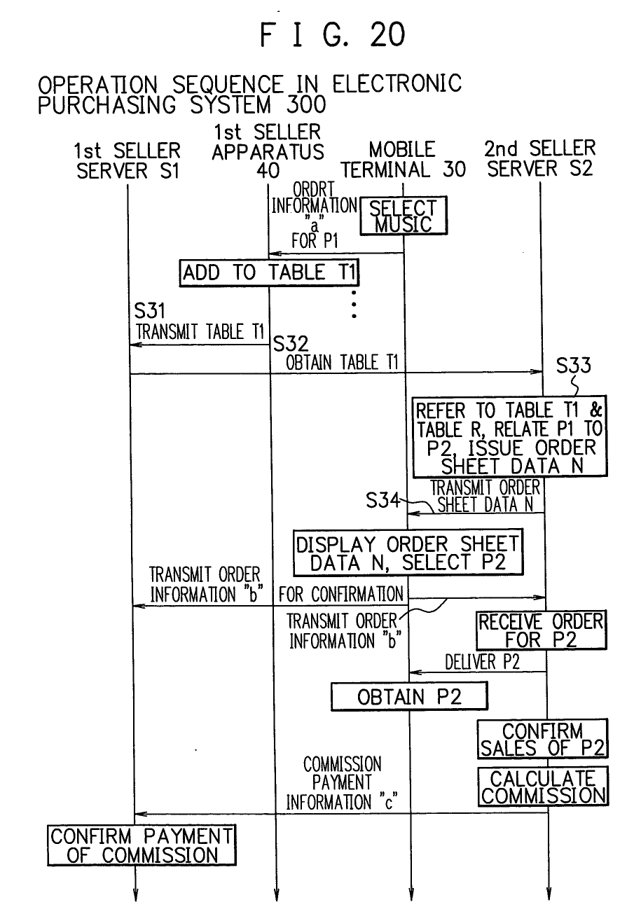

Next, the operation of the electronic purchasing system 300 at the third embodiment of the present invention is explained. FIG. 20 is a diagram showing an operation sequence of the electronic purchasing system 300 at the third embodiment of the present invention. At the third embodiment of the present invention, in FIG. 19, the plural first seller apparatuses 40 are not shown, however, as mentioned at the second embodiment, the first seller system 10 provides the plural first seller apparatuses 40. That is, the processes, which the mobile terminal 30 transmits the order information “a” to the first seller apparatus 40 near the mobile terminal 30 and purchases a first product P1, is the same at the second embodiment of the present invention.

Referring to FIG. 20, the operation sequence of the electronic purchasing system 300 at the third embodiment of the present invention is explained. In the explanation of the operation sequence of the electronic purchasing system 300 at the third embodiment of the present invention, the operation is explained from the operation transmitting the first product purchased record T1 to the first seller server S1 to the operation transmitting the order sheet data N to the mobile terminal 30. The other operation is the same that at the second embodiment shown in FIG. 18.

The first seller apparatus 40 transmits the information of the first product purchased record T1 to the first seller server S1 at the designated timing by using the communication function to server 43, that is, the table of the first product purchased record T1 is transmitted (step S31). And the first seller server S1 receives the first product purchased record T1 from the first seller apparatus 40, and adds the information of the first product purchased record T1 to the information of the other first product purchased records Ti transmitted from the other first seller apparatuses 40.

The first seller system 10 transmits the first product purchased record T1 (T1′) to the second seller server S2 in the second seller system 20, which has a contract with the first seller system 10, in the designated form such as an e-mail attaching form. In the first product purchased record T1 (Tl′), the address information A3 of the mobile terminal 30 is included, this address information A3 is used for transmitting the order sheet data N. At this time, the address information A2 of the second seller server A2 is used. In this, it is possible that the first product purchased record obtaining function 24 in the second seller server S2 accesses to the first seller server S1 and obtains the first product purchased record T1 (T1′).

The second seller server S2 obtains the first product purchased record T1 (T1′) from the e-mail, in which the first product purchased record T1 (T1′) is attached, received from the first seller system 10 at the first product purchased record obtaining function 24, that is, the table of the first product purchased record T1 (T1′) is obtained (step S32).

The order sheet issuing function 25 in the second seller server S2 relates some second product(s) P2 to the first product(s) Pl purchased by the user, by referring to the first product purchased record T1 (T1′), the relation table R, and the second product information L2 at the designated timing. In case that the relation table R has been already made by matching the first products P1 with the second products P2. The relation table R is referred to. And the order sheet data N, in which the combined information of the first product purchased record T1′ of each of the users and the second product information L2′ relating to the first product purchased record T1′ is included as the display information, are issued (step S33). And the order sheet transmitting function 26 transmits the order sheet data N to the mobile terminal 30 by using the address information A3 of the mobile terminal 30 (step S34).

Next, the fourth embodiment of the present invention is explained. At the fourth embodiment of the present invention, an electronic purchasing system 400 is used. The basic structure of the electronic purchasing system 400 is the same that the electronic purchasing system 300 at the third embodiment has. At the electronic purchasing system 400, the second seller system 20 obtains the first product purchased record T1 from the first seller system 10, and pays a commission for the obtained information to the first seller system 10. That is, the commission paying function 23 in the second seller server S2 calculates the commission for the information in a basis such as the number of obtained times and the amount of the obtained data, based on the obtaining of the first product purchased record T1. And the commission payment information “c”, in which the commission for the second products P2 and the calculated commission for obtaining the first product purchased record T1 are included, is transmitted to the first seller system 10.

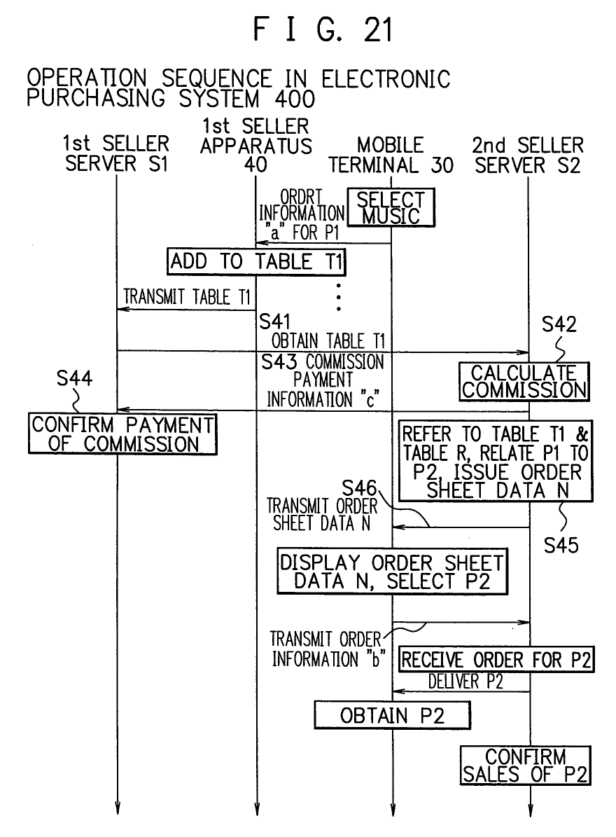

Next, the operation of the electronic purchasing system 400 at the fourth embodiment of the present invention is explained. FIG. 21 is a diagram showing an operation sequence of the electronic purchasing system 400 at the fourth embodiment of the present invention.

Referring to FIG. 21, the operation sequence of the electronic purchasing system 400 at the fourth embodiment of the present invention is explained. In the explanation of the operation sequence of the electronic purchasing system 400 at the fuorth embodiment of the present invention, the operation is explained from the operation obtaining the first product purchased record T1 from the first seller system 10 to the operation transmitting the order sheet data N to the mobile terminal 30. The other operation is the same that at the third embodiment. However, at the fourth embodiment of the present invention, the payment of the commission is executed before that the mobile terminal 30 purchases some second products P2.

The second seller server S2 in the second seller system 20 obtains the first product purchased record T1 from the first seller system 10 at the first product purchased record obtaining function 24 via a communication network, and stores it in the memory of the second seller system 20 (step S41). And the second seller server S2 calculates the commission for obtaining the first product purchased record T1 at the commission paying function 23 (step S42). After this, the commission paying function 23 transmits the commission payment information “c”, in which the commission for obtaining the first product purchased record T1 is included, to the first seller server S1 (step S43). The first seller server S1 confirms whether the commission has been paid normally or not based on the received commission payment information “c” (step S44).

The second seller server S2 in the second seller system 20 issues the order sheet data N by referring to the first product purchased record T1 and the relation table R (step S45). And the second server S2 transmits the order sheet data N to the mobile terminal 30 of the user (step S46).

At the operation sequence mentioned above, the second seller system 20 transmitted the commission payment information “c”, after obtaining the first product purchased record T1 from the first seller system 10 and calculating the commission for the first product purchased record T1. However, the commission payment information “c” can be transmitted at the timing, after issuing and transmitting the order sheet data N, or after delivering the second product(s) P2 based on the reception of the order information “b”.

Next, the fifth embodiment of the present invention is explained. At the fifth embodiment of the present invention, an electronic purchasing system 500 is used. At the electronic purchasing system 500 of the fifth embodiment of the present invention, the relation between the first products P1 and the second products P2 is automatically made by a computer. In order to realize this, the first seller system 10 or the second seller system 20 further provides a function that obtains the product information of the other system via a communication network and a function that makes (renews) the relation table R by matching the product information in its own system and the product information in the other system and holds the relation table R.

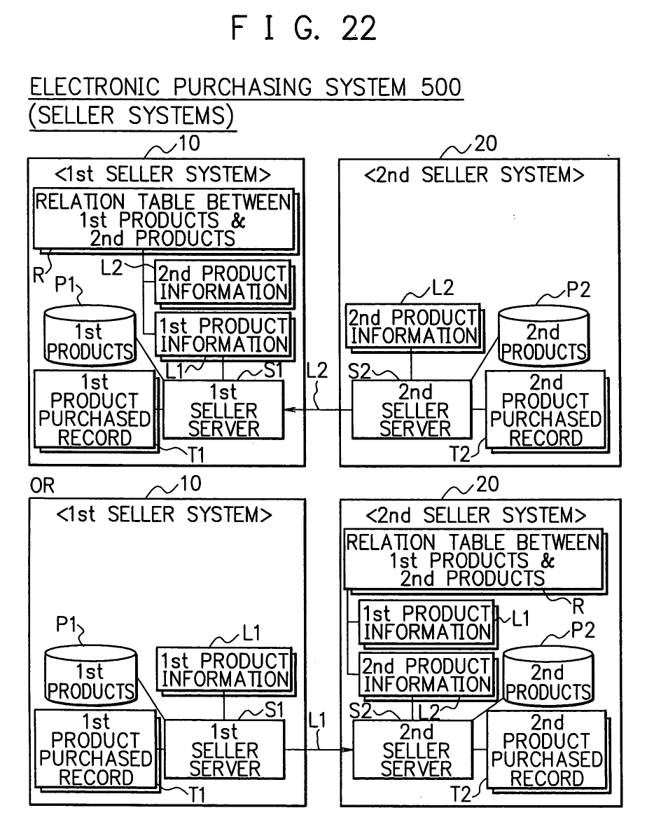

FIG. 22 is a block diagram showing the structure of the electronic purchasing system 500 at the fifth embodiment of the present invention. In FIG. 22, only the first seller system 10 and the second seller system 20 are shown.

Either the first seller system 10 or the second seller systems 20 can provide the functions mentioned above, a case that the first seller system 10 provides the functions is explained.

As shown in FIG. 12, the first seller server S1 in the first seller system 10 provides a second product information obtaining function 16 and a relation table making function 17. The second product information obtaining function 16 is a function that obtains the copy of the second product information L2 from the second seller system 20 via a communication network at the designated timing, and stores the obtained information in the memory in the first seller system 10. In this, this can be said that the second seller system 20 provides a function that transmits the second product information L2 to the first seller system 10 at the designated timing.

The relation table making function 17 is a function that makes the relation table R by matching the first products P1 in the first product information L1 in the first seller system 10 with the second products P2 in the obtained second product information L2. And in the relation table R, each of the first products P1 and each of the second products P2 are related with each other in the designated form.

At the fifth embodiment of the present invention, since this matching operation is executed by the computer, the product information of the first and second products P1 and P2 are supplied in a digital form including the text information. That is, the information of each product is in media such as a product list, a catalog, and an advertisement, and these media are supplied in the digital form. Furthermore, the product information of the first products P1 and P2 is supplied from respective different sellers, therefore, the forms describing the products are different in many cases. Based on these premises, the computer executes the matching operation between the first products P1 and the second products P2, and the relation table R between the first products P1 and the second products P2 is made. In case that the digital forms of the first and second products P1 and P2 are the same, the computer can easily execute the matching operation.

In case that the text information is included in the first product information L1 and the second product information L2, the operation relating the first products P1 with the second products P2 can be executed by the matching operation (searching and comparing operation) for the text information. For example, a word in the first product information L1 is also found in the second product information L2, or the searching operation is applied to the first product information L1 and the second product information L2 by using a predetermined word. With this searching operation, each of the first products P1 and each of the second products P2 can be related with each other.

For example, in case that the first product P1 is a service playing some karaoke music and the second product P2 is some ringing tone music data, a coincidence may be found in the name of the music and the name of the singer. That is, the relation can be clear by that the name of the music and the name of the singer are matched with each other in the text information. Or an existing ambiguous searching method (similar word searching method) can be applied to the matching operation for the text information.

By repeating the product information obtaining operation and the relation table making operation at the designated timing, the relation table R can be renewed. Or the relation table R can be renewed by that the second product information obtaining function 16 and the relation table making function 17 are worked every time when the order sheet data N is issued. At the making of the relation table R, a manual operation can be used in addition to the computer operation.

As mentioned above, according to the present invention, at an electronic purchasing system using mobile terminals such as mobile communication terminals, when the user of the mobile terminal ordered and purchased a first product from a first seller by using his/her own mobile terminal, the user can obtain the first product purchased record of the user. By viewing the first product purchased record, the user can confirm the detail information of the purchased first products. Further, the user can view the second product information that is supplied with the first product purchased record. By viewing the second product information, the user can order and purchase some second product(s) by selecting from the second product information by a simple selection operation.

According to the present invention, the second product information, which is supplied to the user, is the second product information of the second product(s), which is related to the first product(s) purchased by the user. Therefore, in case that the second product information is the information that is supplied to the user at random without the intention of the user, this information bothers the user, however, this supplied information does not bother the user, because this supplied information relates to the first product(s) that the user purchased. Moreover, the user can order some second product(s), which relates to the purchased first product(s) and is interested in by the user, by viewing the first product purchased record and the second product information relating to the first product(s) purchased by the user. Furthermore, the user can order and purchase some second product(s) by an simple operation on the mobile terminal, compared with a conventional complex operation such as searching products and inputting much character information. Therefore, this operation can give convenience to the user.

And according to the present invention, the first seller can obtain a commission for advertisement effect for the second product(s) by supplying the second product information to the user with the sales of the first product(s). And the first seller can adds a value to the first product(s) by supplying the first product purchased record to user as its expanding service.

And according to the present invention, the second seller can promote the second product(s) by using order sheet data, which are issued corresponding to the purchase of the first product(s) by the user. With this, the second product can be advertised effectively.

As mentioned above, according to the present invention, the second product(s) can be advertised effectively based on the sales of the first product(s), and the second product(s) can be promoted easily. And the first seller can obtain the commission for the advertisement effect of the second product(s). And the user can obtain the convenience for ordering and purchasing the second product(s).

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. An electronic purchasing system, comprising:
mobile terminals of users having a radio communication function;
a first seller system for selling first products; and
a second seller system for selling second products, wherein:
each of said users of said mobile terminals purchases said first product(s) by executing an order process for said first seller system by operating said mobile terminal,
said first seller system transmits order sheet data, in which the information of first product purchased record of each of the users and second product information of said second product(s) relating to said first product(s) purchased by said user are described as combined information, to said mobile terminal of said user based on the purchase of said first product(s) by said user,
said user views said order sheet data on said mobile terminal, and
when said user selects some second product(s) in said second product information, an order process for said second product(s) selected by said user is executed to said second seller system, and said second seller system delivers said second product(s) ordered by said user to said mobile terminal of said user, and
said second seller system pays a commission to said first seller system as an advertisement effect for said second product(s).

2. An electronic purchasing system, comprising:
mobile terminals of users having a radio communication function;
a first seller system for selling first products having a first seller server; and
a second seller system for selling second products having a second seller server, wherein:
each of said mobile terminals, comprising:
a means that transmits first product order information for said first product(s) to said first seller server by an operation of said user, and
said first seller server, comprising:
a means that receives said first product order information from said mobile terminal, and delivers said first product(s) to said mobile terminal, and makes a first product purchased record for said first product(s) purchased by said user;
a means that relates said first product(s) purchased by said user to said second product(s) by referring to the information in said first product purchased record, and issues order sheet data, in which said information of said first product purchased record of each of the users and second product information of said second product(s) relating to said first product(s) purchased by said user are included in a combined state as display information, and further in which an process instruction that instructs to transmit second product order information to said second seller server when said user selected some second product(s) is described; and
a means that transmits said order sheet data to said mobile terminal, and
each of said mobile terminals, further comprising:
a means that displays said display information in said order sheet data, and transmits said second product order information to said second seller server when some second product(s) was selected by said user on said display information, and
said second seller server, comprising:
a means that receives said second product order information and delivers said second product(s) to said mobile terminal; and
a means that calculates a commission to be paid to said first seller system and transmits commission payment information including information of said calculated commission to said first seller server, and
said first seller server, further comprising:
a means that confirms said commission payment based on said commission payment information.

3. An electronic purchasing system, comprising:
mobile terminals of users having a radio communication function and a short distance communication function;
a first seller system for selling first products having a first seller server and plural first seller apparatuses connecting to said first seller server; and
a second seller system for selling second products having a second seller server, wherein:
each of said mobile terminals, comprising:
a means that transmits first product order information for said first product(s) to one of said plural first seller apparatuses via said short distance communication function by an operation of said user, and
each of said plural first seller apparatuses, comprising:
a means that receives said first product order information from said mobile terminal, and delivers said first product(s) to said mobile terminal, and makes a first product purchased record for said first product(s) purchased by said user, and
said first seller system, comprising:
a means that relates said first product(s) purchased by said user to said second product(s) by referring to the information in said first product purchased record, and issues order sheet data, in which said information of said first product purchased record of each of the users and second product information of said second product(s) relating to said first product(s) purchased by said user are included in a combined state as display information, and further in which an process instruction that instructs to transmit second product order information to said second seller server when said user selected some second product(s) is described; and
a means that transmits said order sheet data to said mobile terminal, and
each of said mobile terminals, further comprising:
a means that displays said display information in said order sheet data, and transmits said second product order information to said second seller server when some second product(s) was selected by said user on said display information, and
said second seller server, comprising:
a means that receives said second product order information and delivers said second product(s) to said mobile terminal; and
a means that calculates a commission to be paid to said first seller system and transmits commission payment information including information of said calculated commission to said first seller server, and
said first seller server, comprising:
a means that confirms said commission payment based on said commission payment information.

4. An electronic purchasing system, comprising:
mobile terminals of users having a radio communication function;
a first seller system for selling first products having a first seller server; and
a second seller system for selling second products having a second seller server, wherein:
each of said mobile terminals, comprising:
a means that transmits first product order information for said first product(s) to said first seller server by an operation of said user, and
said first seller server, comprising:
a means that receives said first product order information from said mobile terminal, and delivers said first product(s) to said mobile terminal, and makes a first product purchased record for said first product(s) purchased by said user, and
said second seller server, comprising:
a means that obtains the information of said first product purchased record from said first seller server;
a means that relates said first product(s) purchased by said user to said second product(s) by referring to the information in said first product purchased record, and issues order sheet data, in which said information of said first product purchased record of each of the users and second product information of said second product(s) relating to said first product(s) purchased by said user are included in a combined state as display information, and further in which an process instruction that instructs to transmit second product order information to said second seller server when said user selected some second product(s) is described; and
a means that transmits said order sheet data to said mobile terminal, and
each of said mobile terminals, further comprising:
a means that displays said display information in said order sheet data, and transmits said second product order information to said second seller server when some second product(s) was selected by said user on said display information, and
said second seller server, further comprising:
a means that receives said second product order information and delivers said second product(s) to said mobile terminal; and
a means that calculates a commission to be paid to said first seller system and transmits commission payment information including information of said calculated commission to said first seller server, and
said first seller server, further comprising:
a means that confirms said commission payment based on said commission payment information.

5. An electronic purchasing system in accordance with claim 4, wherein:
said second seller system calculates an information fee for the reception of the information of said first product purchased record from said first seller server as an additional commission to said first seller system and pays said information fee in addition to said commission to said first seller system.

6. An electronic purchasing system in accordance with claims 2 or 3, wherein:
said first seller system holds said second product information supplying from said second seller system beforehand and relates said second product(s) to said first product(s) by suing said first product information and said second product information, and issues said order sheet data.

7. An electronic purchasing system in accordance with claim 4, wherein:
said second seller system holds said first product information supplying from said first seller system beforehand and relates said second product(s) to said first product(s) by suing said first product information and said second product information, and issues said order sheet data.

8. An electronic purchasing system in accordance with any of claims 2 to 4, wherein:
a relation table between said first products and said second products is made beforehand, and said relation table is referred to when said order sheet data are issued.

9. An electronic purchasing system in accordance with claims 2 or 3, wherein:
said first seller system provides said first product information, and said second seller system provides said second product information, and
said first seller system, further comprising:
a means that obtains said second product information from said second seller system; and
a means that makes and renews a relation table in which the relation between said first products and said second products is described by applying a matching process to said first product information and said second product information obtained from said second seller system, and
when said order sheet data are issued, said order sheet data are issued by referring to said relation table and making the relation between said first products and said second products.

10. An electronic purchasing system in accordance with claim 4, wherein:
said first seller system provides said first product information, and said second seller system provides said second product information, and
said second seller system, further comprising:
a means that obtains said first product information from said first seller system; and
a means that makes and renews a relation table in which the relation between said first products and said second products is described by applying a matching process to said second product information and said first product information obtained from said first seller system, and
when said order sheet data are issued, said order sheet data are issued by referring to said relation table and making the relation between said first products and said second products.

11. An electronic purchasing system in accordance with claims 9 or 10, wherein:
at said matching process, text information in said first product information and said second product information is searched and compared, and when the same word is searched, the relation between said first products and said second products is made.

12. An electronic purchasing system in accordance with any of claims 2 to 4, wherein:
when said first product order information is transmitted, address information of said mobile terminal is also transmitted, and
when said order sheet data are transmitted, said address information of said mobile terminal is used as destination information.

13. An electronic purchasing system in accordance with any of claims 2 to 4, wherein:
when said order sheet data are issued, address information of said second seller server is also described in said order sheet data, and
when said second product order information is transmitted, said address information of said second seller server is used as destination information.

14. An electronic purchasing system in accordance with any of claims 2 to 4, wherein:
when said order sheet data are issued, address information of said first seller server is also described in said order sheet data,
when said second product order information is transmitted from said mobile terminal to said second seller server, said address information of said first seller server is also used as destination information, and the same data in said second product order information is transmitted to said first seller server for confirmation, and
said first seller system confirms said commission payment by referring to said second product order information.

15. An electronic purchasing system in accordance with any of claims 2 to 4, wherein:
an e-mail address is used as said address information of said mobile terminal, and
said first or second seller system transmits said order sheet data in the e-mail form by using the e-mail protocol.

16. An electronic purchasing system in accordance with any of claims 2 to 4, wherein:
said first products are digital data, and
said first seller system transmits said digital data to said mobile terminal by receiving said first product order information.

17. An electronic purchasing system in accordance with any of claims 2 to 4, wherein:
said second products are digital data, and
said second seller system transmits said digital data to said mobile terminal by receiving said second product order information.

18. An electronic purchasing system in accordance with any of claims 2 to 4, wherein:
said information of said first product purchased record and said second product information of each of said users, being said display information in said order sheet data, are displayed in different pages on the screen of said mobile terminal in a state that said different pages are changed over.

19. An electronic purchasing system in accordance with any of claims 2 to 4, wherein:
said information of said first product purchased record and said second product information of each of said users, being said display information in said order sheet data, are displayed in the same page on the screen of said mobile terminal in a state that both of said information is combined.

20. An electronic purchasing system in accordance with claim 3, wherein:
said first seller system is a system that offers karaoke music data as said first products,
each of said plural first seller apparatuses is a communication karaoke apparatus and plays karaoke music corresponding to the reception of said first product order information from each of said mobile terminals, and
said second seller system is a system that offers ringing tone music data as said second products, wherein:
said second seller server holds said ringing tone music data and transmits said ringing tone music data to each of said mobile terminals corresponding to the reception of said second product order information from each of said mobile terminals.

21. An electronic purchasing method in a system, in which mobile terminals of users having a radio communication function, a first seller system for selling first products having a first seller server, and a second seller system for selling second products having a second seller server are provided, comprising the steps of:
transmitting first product order information for said first product(s) to said first seller server by an operation of said user at each of said mobile terminals;
receiving said first product order information from said mobile terminal at said first seller server;
delivering said first product(s) to said mobile terminal at said first seller server;
making a first product purchased record for said first product(s) purchased by said user at said first seller server;
relating said first product(s) purchased by said user to said second product(s) by referring to the information in said first product purchased record at said first seller server;
issuing order sheet data, in which said information of said first product purchased record of each of the users and second product information of said second product(s) relating to said first product(s) purchased by said user are included in a combined state as display information, and further in which an process instruction that instructs to transmit second product order information to said second seller server when said user selected some second product(s) is described at said first seller server;
transmitting said order sheet data to said mobile terminal at said first seller server;
displaying said display information in said order sheet data at said mobile terminal;
transmitting said second product order information to said second seller server when some second product(s) was selected by said user on said display information at said mobile terminal;
receiving said second product order information and delivering said second product(s) to said mobile terminal at said second seller server;
calculating a commission to be paid to said first seller system and transmitting commission payment information including information of said calculated commission to said first seller server at said second seller server; and
confirming said commission payment based on said commission payment information at said first seller sever.

22. An electronic purchasing method in a system, in which mobile terminals of users having a radio communication function and a short distance communication function, a first seller system for selling first products having a first seller server and plural first seller apparatuses connecting to said first seller server, and a second seller system for selling second products having a second seller server are provided, comprising the steps of:
transmitting first product order information for said first product(s) to one of said plural first seller apparatuses via said short distance communication function by an operation of said user at each of said mobile terminals;
receiving said first product order information from said mobile terminal, and delivering said first product(s) to said mobile terminal, and making a first product purchased record for said first product(s) purchased by said user at each of said plural first seller apparatuses;
relating said first product(s) purchased by said user to said second product(s) by referring to the information in said first product purchased record at said first seller system;
issuing order sheet data, in which said information of said first product purchased record of each of the users and second product information of said second product(s) relating to said first product(s) purchased by said user are included in a combined state as display information, and further in which an process instruction that instructs to transmit second product order information to said second seller server when said user selected some second product(s) is described at said first seller system;
transmitting said order sheet data to said mobile terminal at said first seller system;
displaying said display information in said order sheet data, and transmitting said second product order information to said second seller server when some second product(s) was selected by said user on said display information at each of said mobile terminals;
receiving said second product order information and delivering said second product(s) to said mobile terminal at said second seller server;
calculating a commission to be paid to said first seller system and transmitting commission payment information including information of said calculated commission to said first seller server at said second seller server; and
confirming said commission payment based on said commission payment information at said first seller server.

23. An electronic purchasing method in a system, in which mobile terminals of users having a radio communication function, a first seller system for selling first products having a first seller server, and a second seller system for selling second products having a second seller server are provided, comprising the steps of:
transmitting first product order information for said first product(s) to said first seller server by an operation of said user at each of said mobile terminals;
receiving said first product order information from said mobile terminal, and delivering said first product(s) to said mobile terminal, and making a first product purchased record for said first product(s) purchased by said user at said first seller server;
obtaining the information of said first product purchased record from said first seller server at said second seller server;
relating said first product(s) purchased by said user to said second product(s) by referring to the information in said first product purchased record at said second seller server;
issuing order sheet data, in which said information of said first product purchased record of each of the users and second product information of said second product(s) relating to said first product(s) purchased by said user are included in a combined state as display information, and further in which an process instruction that instructs to transmit second product order information to said second seller server when said user selected some second product(s) is described at said second seller server;
transmitting said order sheet data to said mobile terminal at said second seller server;
displaying said display information in said order sheet data, and transmitting said second product order information to said second seller server when some second product(s) was selected by said user on said display information at each of said mobile terminals;
receiving said second product order information and delivering said second product(s) to said mobile terminal at said second seller server;
calculating a commission to be paid to said first seller system and transmitting commission payment information including information of said calculated commission to said first seller server at said second seller server; and
confirming said commission payment based on said commission payment information at said first seller server.

24. An electronic purchasing method in a system, in which mobile terminals of users having a radio communication function, a first seller system for selling first products having a first seller server, and a second seller system for selling second products having a second seller server are provided, comprising the steps of:
transmitting first product order information for said first product(s) to said first seller server by an operation of said user at each of said mobile terminals;
receiving said first product order information from said mobile terminal, and delivering said first product(s) to said mobile terminal, and making a first product purchased record for said first product(s) purchased by said user at said first seller server;
obtaining the information of said first product purchased record from said first seller server at said second seller server;
calculating an information fee for the reception of the information of said first product purchased record from said first seller server as an additional commission to said first seller system at said second seller server;
relating said first product(s) purchased by said user to said second product(s) by referring to the information in said first product purchased record at said second seller server;
issuing order sheet data, in which said information of said first product purchased record of each of the users and second product information of said second product(s) relating to said first product(s) purchased by said user are included in a combined state as display information, and further in which an process instruction that instructs to transmit second product order information to said second seller server when said user selected some second product(s) is described at said second seller server;
transmitting said order sheet data to said mobile terminal at said second seller server;
displaying said display information in said order sheet data, and transmitting said second product order information to said second seller server when some second product(s) was selected by said user on said display information at each of said mobile terminals;
receiving said second product order information and delivering said second product(s) to said mobile terminal at said second seller server;
calculating a commission to be paid to said first seller system for the purchase of said second product(s) by said user of said mobile terminal at said second seller server;
transmitting commission payment information including information of said calculated commission and said information fee to said first seller server at said second seller server; and
confirming said commission payment including said information fee based on said commission payment information at said first seller server.

25. An electronic purchasing method in accordance with claims 21 or 22, further comprising the steps of:
obtaining said second product information from said second seller system at said first seller system; and
making and renewing a relation table in which the relation between said first products and said second products is described by applying a matching process to said first product information and said second product information obtained from said second seller system at said first seller system, wherein:
when said order sheet data are issued, said order sheet data are issued by referring to said relation table and making the relation between said first products and said second products.

26. An electronic purchasing method in accordance with claims 23 or 24, further comprising the steps of:
obtaining said first product information from said first seller system at said second seller system; and
making and renewing a relation table in which the relation between said first products and said second products is described by applying a matching process to said second product information and said first product information obtained from said first seller system at said second seller system, wherein:
when said order sheet data are issued, said order sheet data are issued by referring to said relation table and making the relation between said first products and said second products.

27. A server, which is a server of a first seller that sells first products to mobile terminals having a radio communication function of users, comprising:
a function that receives first product order information from each of said mobile terminal, and delivers said first product(s) to each of said mobile terminal;
a function that makes a first product purchased record for said first product(s) purchased by each of said users;
a function that relates said first product(s) purchased by each of said users to second product(s) of a second seller by referring to the information in said first product purchased record;
a function that issues order sheet data, in which said information of said first product purchased record of each of the users and second product information of second product(s) relating to said first product(s) purchased by each of said users are included in a combined state as display information, and further in which an process instruction that instructs to transmit second product order information to a server of said second seller when each of said users selected some second product(s) is described;
a function that transmits said order sheet data to each of said mobile terminals; and
a function that confirms a commission payment from said second seller based on commission payment information transmitted from said second seller.

28. A server in accordance with claim 27, wherein:
said sever holds said product information of said first products, and
said server, further comprising:
a function that obtains said product information of said second products from a system of said second seller; and
a function that makes and renews a relation table in which the relation between said first products and said second products is described by applying a matching process to said product information of said first products and said product information of said second products obtained from said system of said second seller, wherein:
when said order sheet data are issued, said order sheet data are issued by referring to said relation table and making the relation between said first products and said second products.

29. A server, which is a server of a second seller that sells second products to mobile terminals having a radio communication function of users, comprising:
a function that receives second product order information issued based on order sheet data made by a system of a first seller from each of said mobile terminals, and delivers said first product(s) to each of said mobile terminal; and
a function that calculates a commission to be paid to said first seller, and transmits commission payment information including said calculated commission to said system of said first seller.

30. A server in accordance with claim 29, further comprising:
a function that obtains information of a first product purchased record for first products purchased by each of said users from said system of said first seller;
a function that relates said second products to said first products purchased by each of said users by referring to said information in said first product purchased record;
a function that issues order sheet data, in which said information of said first product purchased record of each of the users and product information of second product(s) relating to said first product(s) purchased by each of said users are included in a combined state as display information, and further in which an process instruction that instructs to transmit second product order information to a server of said second seller; and
a function that transmits said order sheet data to each of said mobile terminals.

31. A server in accordance with claim 30, wherein:
said server holds said product information of said second products, and
said server, further comprising:
a function that obtains said product information of said first products from a system of said first seller; and
a function that makes and renews a relation table in which the relation between said first products and said second products is described by applying a matching process to said product information of said second products and said product information of said first products obtained from said system of said first seller, wherein:
when said order sheet data are issued, said order sheet data are issued by referring to said relation table and making the relation between said first products and said second products.

32. An terminal apparatus, which is provided in a first seller system that delivers first product(s) to each of mobile terminals having a communication function of users and is connected to a server of said first seller system via a communication network, comprising:
a function that delivers said first product(s) to each of said mobile terminals by communicating with said server;
a function that receives first product information from each of said mobile terminals via short distance communication, and delivers said first product(s) to each of said mobile terminals; and
a function that makes a first product purchased record based on the delivery of said first product(s) to each of said mobile terminals.

33. An terminal apparatus in accordance with claim 32, further comprising:
a function that relates said first product(s) purchased by each of said users to second product(s) of a second seller by referring to the information in said first product purchased record;
a function that issues order sheet data, in which said information of said first product purchased record of each of the users and second product information of second product(s) relating to said first product(s) purchased by each of said users are included in a combined state as display information, and further in which an process instruction that instructs to transmit second product order information to a server of said second seller when each of said users selected some second product(s) is described; and
a function that transmits said order sheet data to each of said mobile terminals.
